(19) United States
(12) Patent Application Publication
(10) Pub. No.: US 2025/0306546 A1
(43) Pub. Date: Oct. 2, 2025

(54) SYSTEMS AND METHODS FOR OPTIMIZATION OF A BUILDING MANAGEMENT SYSTEM

(71) Applicant: BECA LIMITED, Auckland (NZ)

(72) Inventors: Benjamin John NEILSON, Auckland (NZ); Shaan Steven Hardiment CORY, Auckland (NZ); Glenn Paul ANDERT, Auckland (NZ)

(21) Appl. No.: 18/864,238

(22) PCT Filed: May 8, 2023
(86) PCT No.: PCT/IB2023/054733

§ 371 Date: Nov. 8, 2024

(30) Foreign Application Priority Data
May 12, 2022 (NZ) 788147

(51) Int. Cl. G05B 13/04

(52) U.S. Cl. CPC G05B 13/042; G05B 13/041

(57) ABSTRACT

A building management system (BMS) optimization system for optimizing an existing BMS of a building. The system has a cloud platform that is configured to analyse existing building behaviour and recommend one or more optimized control strategies from a strategy library to improve the building behaviour. An onsite controller is provided that is in data communication with the pre-existing BMS of a building, and which is configured to implement the recommended optimized control strategies from the cloud platform by overriding set points in the BMS in real-time to thereby optimize the building behaviour. A data network or data communication link is provided between cloud platform and onsite controller.

### FIELD OF THE DISCLOSURE

This disclosure relates to systems and method for optimizing a building management system.

### BACKGROUND

Building management systems (BMS) (also known as Building Automation Systems—BAS) for buildings are onsite controller systems that operate and control components, systems and/or equipment of the building such as heating, cooling and ventilation systems (e.g. HVAC components and systems) and other building components and/or functionality.

BMS systems are often configured in a customised and/or bespoke way according to the specific building they are controlling. Typically, default software or control code of the BMS is updated or changed overtime by building engineers to customise or re-configure or optimize aspects of the BMS depending on the usage and/or needs of the residents or tenants of the building. Bespoke BMS software upgrades can be time-consuming and costly to deploy on a regular basis.

### SUMMARY

It is an object of at least some embodiments of the present disclosure to provide an improved method and system of optimizing a building management system, and/or to at least provide the industry with a useful choice.

In a first aspect, this disclosure broadly comprises a building management system (BMS) optimization system for optimizing an existing BMS of a building comprising: a cloud platform that is configured to analyse existing building behaviour and recommend one or more optimized control strategies from a strategy library to improve the building behaviour; an onsite controller that is in data communication with the pre-existing BMS of a building, and which is configured to implement the recommended optimized control strategies from the cloud platform by overriding set points in the BMS in real-time to thereby optimize the building behaviour; and a data network or data communication link between cloud platform and onsite controller.

In a configuration, the cloud platform comprises a model builder that is configured or operable to generate, receive and/or retrieve a digital building model of the building, the digital building model generated based on extracting meta data and set points from the BMS relating to equipment instances of the building.

In a configuration, the cloud platform comprises a fault detection and diagnostic (FDD) engine that is configured to process the digital building model, incoming BMS time-series data streams representing operation of the equipment instances of the building, and control strategies from a strategy library to generate recommendation data identifying recommended optimized control strategies for each equipment instance and/or category of equipment instance.

In a configuration, the FDD engine comprises a comparator that is configured or operable to compare nominal control strategy curves or functions to the incoming BMS time-series data streams to generate one or more deviation parameters representing or indicative of the current operation of the equipment instances in the building relative to the nominal control strategy curves or functions, and which generates diagnosis time-series data streams comprising at least the deviation parameters generated by the comparison.

In a configuration, the comparator of the FDD engine receives or retrieves incoming BMS time-series data provided by the BMS that represents, for each equipment instance being analysed, the actual controlled output value for the equipment instance, the process variable set point value associated with the equipment instance, and the actual process variable value associated with the equipment instance.

In a configuration, the diagnosis time-series data streams comprise one or more deviation parameters generated based on or as a function of one or more of: a nominal controlled output value derived from the nominal control strategy curves or functions, the actual controlled output set point value, the process variable set point value, and/or the actual process variable value.

In a configuration, the diagnosis time-series data streams comprises any one or more of the following deviation parameter values: a controlled output deviation value representing the difference between the nominal controlled output value and the actual controlled output set point value; a controlled output Euclidian distance value representing the Euclidian distance between the nominal controlled output value and the actual controlled output set point value; a process variable deviation value representing the difference between the process variable set point value and the actual process variable value; and/or a process variable Euclidian distance value representing the Euclidian distance between the process variable set point value and the actual process variable value.

In a configuration, the FDD engine comprises a recommendation engine that is configured or operable to generate the recommendation data identifying the recommended optimized control strategies for each equipment instance and/or category of equipment instance based at least partly on or as a function of the diagnosis time-series data streams and a recommendation threshold parameter or parameters.

In a configuration, the FDD engine further comprises an augmentation engine that is configured or operable to identify and augment the recommendation data for equipment instances with any existing override data associated with the one or more respective equipment instances, the override data being indicative of any overrides or modifications required to the recommendation data for any applicable equipment instances.

In a configuration, the FDD engine further comprises a rollout planner process that is configured to: identify which equipment instances are designated for which stage of a progressive optimization rollout; determine which optimized control strategies are applicable for each equipment instances identified for each stage based on the recommendation data and any applicable override data; and generate rollout plan data indicative of the optimized control strategies applicable to the equipment instances at each stage of the rollout.

In a configuration, the FDD engine further comprises a rollout implementer engine that is configured to spawn and/or configure an optimizer process in the onsite controller for each equipment instance in accordance with the rollout plan data for each stage of the rollout, each optimizer process being configured to override one or more set points of its associated equipment instance in the BMS in accordance with its linked optimized control strategy.

In a configuration, the onsite controller comprises one or more optimizer processes executing in an optimizer engine, each optimizer process being configured to override set points in the BMS associated with the control of a respective equipment instance of the building in accordance with the recommended optimized control strategy for that equipment instance.

In a configuration, each optimizer process of the onsite controller for an equipment instance is configured to: access or retrieve BMS time-series data representing the process variable set point value and actual process variable value; and override or configure the controlled output set point value in the BMS for the equipment instance to the nominal controlled output value extracted from the nominal control strategy curve or function associated with the recommended optimized control strategy for the equipment instance based at least partly on the BMS time-series data.

In a configuration, the FDD engine comprises a verifier engine that is configured to process the digital building model, incoming BMS time-series data streams representing operation of the equipment instances of the building, and the nominal control strategy curve or function of the optimized control strategy being implemented by the optimizer process for each equipment instance to generate deviation parameters representing or indicative of the current operation of the equipment instances relative to their associated optimized control strategy.

In a configuration, the verifier engine is configured to generate fault data for one or more of the equipment instances based on comparing the deviation parameters to a verification threshold parameter or parameters.

In a configuration, the FDD engine comprises a monitoring engine that is configured to process the digital building model, incoming BMS time-series data streams representing operation of the equipment instances of the building, and the nominal control strategy curve or function of the optimized control strategy being implemented by the optimizer process for each equipment instance to generate deviation parameters representing or indicative of the current operation of the equipment instances relative to their associated optimized control strategy.

In a configuration, the monitoring engine is configured to generate fault data for one or more of the equipment instances based on comparing the deviation parameters to a monitoring threshold parameter or parameters.

In a configuration, the verification threshold(s) are configured with a higher sensitivity to error compared to the monitoring threshold(s).

In a configuration, the onsite controller is an edge computer that is in data communication with the pre-existing BMS via a BMS communication protocol.

In a configuration, the BMS communication protocol is BACnet (Building Automation Control Network).

In a configuration, the onsite controller is configured to override the set points of the pre-existing BMS via a command priority mechanism or system of a BMS communication protocol.

In a configuration, the onsite controller is configured to generate commands having an associated configured priority level for execution, the commands comprising set points for controlling equipment instances of the building and which are generated in accordance with the optimized control strategies.

In a configuration, the commands generated by the onsite controller have a configured priority level for execution that is higher than commands generated by the pre-existing BMS such that the set points generated by the onsite controller override the set points generated by the pre-existing BMS.

In a configuration, commands generated by the onsite controller have a configured priority level for execution that is higher than commands generated by the pre-existing BMS and lower than a predetermined or configurable safety priority level.

In a configuration, the BMS protocol is BACnet and commands to control set points of equipment instances of the building are executed in accordance with a command priority array based on the priority level configured for generated commands.

In a configuration, the pre-existing BMS is agnostic to the overriding control of building behaviour exerted by the onsite controller.

In a configuration, the onsite controller is configured to override control of one or more aspects of the building behaviour in accordance with the optimized control strategies without requiring modification of the native control logic of the pre-existing BMS.

In a configuration, the pre-existing BMS continues to attempt to exert control over the building behaviour in accordance with its native control logic by generating commands to control set points of one or more equipment instances, but wherein at least a portion of the BMS-generated commands are overridden by higher-priority commands generated by the onsite controller in accordance with the optimized control strategies.

In a configuration, the onsite controller is configured to exert overriding control over one or more aspects of the building behvaiour based on the optimized control strategies, while any remaining aspects of the building behvaiour remain controlled by the pre-existing BMS.

In a configuration, the one or more aspects of building behaviour may comprise controlling specific sets or groups or areas of equipment instances of the building.

In a configuration, the pre-existing BMS seamlessly resumes full control of the building behaviour if the onsite controller goes offline.

In a configuration, the pre-existing BMS resumes full control of the building behaviour by virtue of BMS-generated commands to control building behaviour becoming effective again once any overriding higher-priority commands from the offline onsite controller cease to override the BMS-generated commands.

In a second aspect, this disclosure broadly comprises a method of optimizing the operation of a pre-existing building management system (BMS) of a building comprising using a BMS optimization system comprising a cloud platform that is in data communication over a data network with an onsite controller, the onsite controller being in data communication with the pre-existing BMS, the method comprising: generating, receiving and/or retrieving a digital building model of the building in the cloud platform; processing in the cloud platform the digital building model, incoming BMS time-series data streams representing operation of the equipment instances of the building, and control strategies from a strategy library to generate recommendation data identifying recommended optimized control strategies for each equipment instance and/or category of equipment instance; and configuring the onsite controller to implement the recommended optimized control strategies for the equipment instances by overriding set points in the BMS in real-time to thereby optimize the building behaviour.

The second aspect of the disclosure may have any one or more of the features or aspects mentioned in respect of the first aspect of the disclosure.

In a third aspect, this disclosure broadly comprises a system for optimizing building behavior of a building comprising: an analysis system that is configured to analyse existing building behaviour and generate or select one or more optimized control strategies for execution by an optimization engine to improve one or more aspects of building behaviour; a pre-existing building management system (BMS) executing native control logic to control building behaviour via BMS-generated commands; and an optimization engine that receives and executes the optimized control strategies to override one or more aspects of the native control logic of the pre-existing BMS by generating higher-priority commands than the BMS-generated commands to improve those one or more aspects of building behaviour.

In a configuration, the commands comprise set points for controlling equipment instances of the building.

In a configuration, the commands are generated and executed in accordance with a BMS communication protocol to control equipment instances of the building.

In a configuration, the BMS communication protocol is BACnet and the equipment instances are BACnet devices.

In a configuration, the commands are executed in accordance with a command prioritization mechanism or system of the BMS communication protocol.

In a configuration, the command prioritization mechanism or system is a command priority array in BACnet.

In a configuration, each generated command comprises a configurable command priority level that determines its priority of execution relative to other competing commands.

In a configuration, the analysis system is a remote or cloud-based system or platform.

In a configuration, the analysis system is in data communication with the optimizer engine over a data network.

In a configuration, the optimizer engine is a separate device, interface or controller that connects or interfaces with the pre-existing BMS.

In a configuration, the optimizer engine is retrofittable to or with the pre-existing BMS.

In a configuration, the optimizer engine is provided in an edge computer that interfaces or is in data communication with the pre-existing BMS.

In a configuration, the optimizer engine is in data communication with the pre-existing BMS via a BACnet communication protocol.

In a configuration, the optimizer engine is installed onsite at the building.

In a configuration, the optimizer engine and pre-existing BMS are virtual machines or software applications which may operate within the same or different computing systems.

In a configuration, the optimizer engine is remote or installed offsite from the building.

In a fourth aspect, this disclosure broadly comprises a method of optimizing building behaviour of a building comprising: generating, receiving and/or retrieving a digital building model of the building; processing the digital building model, incoming time-series data streams representing operation of the equipment instances of the building from a pre-existing building management system (BMS) of the building, and control strategies from a strategy library to generate or identify optimized control strategies for improving one or more aspects of building behaviour; and configuring an optimization engine that interfaces with the pre-existing BMS to implement the optimized control strategies, the optimization engine being configured to overriding one or more aspects of the native control logic of the pre-existing BMS by generating higher-priority commands than the BMS-generated commands to thereby improve one or more aspects of building behaviour.

The third and fourth aspects of the disclosure may have any one or more of the aspects or features mentioned in respect of the first or second aspects of the disclosure above.

In a fifth aspect, this disclosure broadly comprises an optimization engine for optimizing building behaviour of a building comprising: an interface for data communication with a pre-existing BMS of a building and/or equipment instances of the building; memory for storing one or more optimized control strategies that are configured to improve one or more aspects of the building behaviour; and a processor or application configured to execute the one or more optimized control strategies to override one or more aspects of the native control logic of the pre-existing BMS by generating higher-priority commands or set points than BMS-generated commands or set points to improve those one or more aspects of building behaviour.

In a configuration, the optimization engine comprises or is in the form of an edge computer that is in data communication with the pre-existing BMS.

In a configuration, the optimization engine is a virtual machine or software application.

The fifth aspect of the disclosure may have any one or more aspects or features mentioned in respect of any of the first-fourth aspects of the disclosure above.

In a sixth aspect, this disclosure broadly comprises a fault detection and diagnosis (FDD) system for a building management system (BMS) optimization system of a building comprising: a comparator that is configured or operable to compare nominal control strategy curves or functions to incoming BMS time-series data streams for one or more equipment instances of the building to generate one or more deviation parameters representing or indicative of the current operation of the equipment instances in the building relative to the nominal control strategy curves or functions, and which generates diagnosis time-series data streams comprising at least the deviation parameters generated by the comparison; a recommendation engine that is configured or operable to generate the recommendation data identifying recommended optimized control strategies for each equipment instance and/or category of equipment instance based at least partly on or as a function of the diagnosis time-series data streams and a recommendation threshold parameter or parameters; a verification engine that is configured or operable to process a digital building model, the diagnosis time-series data streams for the nominal control strategy curve or function of the optimized control strategy being implemented by an optimizer process for each equipment instance; and generate verification fault data for one or more equipment instances based on comparing the deviation parameters to a verification threshold parameter or parameters; and a monitoring engine that is configured or operable to process a digital building model, the diagnosis time-series data streams for the nominal control strategy curve or function of the optimized control strategy being implemented by an optimizer process for each equipment instance; and generate monitoring fault data for one or more equipment instances based on comparing the deviation parameters to a monitoring threshold parameter or parameters.

In a configuration, the comparator receives or retrieves incoming BMS time-series data provided by the BMS that represents, for each equipment instance being analysed, the actual controlled output value for the equipment instance, the process variable set point value associated with the equipment instance, and the actual process variable value associated with the equipment instance.

In a configuration, the diagnosis time-series data streams comprise one or more deviation parameters generated based on or as a function of one or more of: a nominal controlled output value derived from the nominal control strategy curves or functions, the actual controlled output set point value, the process variable set point value, and/or the actual process variable value.

In a configuration, the diagnosis time-series data streams comprises any one or more of the following deviation parameter values: a controlled output deviation value representing the difference between the nominal controlled output value and the actual controlled output set point value; a controlled output Euclidian distance value representing the Euclidian distance between the nominal controlled output value and the actual controlled output set point value; a process variable deviation value representing the difference between the process variable set point value and the actual process variable value; and/or a process variable Euclidian distance value representing the Euclidian distance between the process variable set point value and the actual process variable value.

In a configuration, the FDD system further comprises an augmentation engine that is configured or operable to identify and augment the recommendation data for equipment instances with any existing override data associated with the one or more respective equipment instances, the override data being indicative of any overrides or modifications required to the recommendation data for any applicable equipment instances.

In a configuration, the FDD system further comprises a rollout planner process that is configured to: identify which equipment instances are designated for which stage of a progressive optimization rollout; determine which optimized control strategies are applicable for each equipment instances identified for each stage based on the recommendation data and any applicable override data; and generate rollout plan data indicative of the optimized control strategies applicable to the equipment instances at each stage of the rollout.

In a configuration, the FDD system further comprises a rollout implementer engine that is configured to spawn and/or configure an optimizer process for each equipment instance in accordance with the rollout plan data for each stage of the rollout, each optimizer process being configured to override one or more set points of its associated equipment instance in the BMS in accordance with its linked optimized control strategy.

In a configuration, the verification threshold(s) are configured with a higher sensitivity to error compared to the monitoring threshold(s).

In a seventh aspect, this disclosure broadly comprises a method of configuring, verifying and monitoring a building management system (BMS) optimization system, the method executed by a fault detection and diagnosis (FDD) engine, comprising: comparing nominal control strategy curves or functions to incoming BMS time-series data streams for one or more equipment instances of the building to generate one or more deviation parameters representing or indicative of the current operation of the equipment instances in the building relative to the nominal control strategy curves or functions, and generating diagnosis time-series data streams comprising at least the deviation parameters generated by the comparison; generating recommendation data identifying recommended optimized control strategies for each equipment instance and/or category of equipment instance based at least partly on or as a function of the diagnosis time-series data streams and a recommendation threshold parameter or parameters; processing a digital building model, the diagnosis time-series data streams for the nominal control strategy curve or function of the optimized control strategy being implemented by an optimizer process for each equipment instance, and generating verification fault data for one or more equipment instances based on comparing the deviation parameters to a verification threshold parameter or parameters; and processing a digital building model, the diagnosis time-series data streams for the nominal control strategy curve or function of the optimized control strategy being implemented by an optimizer process for each equipment instance, and generating monitoring fault data for one or more equipment instances based on comparing the deviation parameters to a monitoring threshold parameter or parameters.

The sixth and seventh aspects of the disclosure may have any one or more features or aspects mentioned in respect of the first-fifth aspects of the disclosure, and vice versa.

In another aspect, this disclosure broadly comprises an electronically-implemented method comprising software code or coded instructions that are executable or implemented by a computer, processor, or controller to carry out any one or more of the methods or aspects described above.

In another aspect, this disclosure broadly comprises a non-transitory computer-readable medium having stored thereon computer executable instructions that, when executed on a processing device or devices, cause the processing device or devices to perform any one or more of the methods or aspects described above.

In another aspect, this disclosure broadly comprises a set of application program interfaces embodied on a computer-readable medium for execution on a processing device in conjunction with an application program that perform any one or more of the methods or aspects described above.

### BRIEF DESCRIPTION OF THE DRAWINGS

These and other features, aspects, and advantages of the present disclosure are described with reference to the drawings of certain embodiments, which are intended to schematically illustrate certain embodiments and not to limit the disclosure.

FIG. 1 is a physical diagram of a deployed BMS optimization system in accordance with an example embodiment;

FIG. 2 is a block diagram of the main components of a BMS optimization system in accordance with the example embodiment;

FIG. 3 is a flow diagram of an example embodiment of the system process flow for the BMS optimization system in accordance with an example embodiment;

FIG. 4 is a flow diagram of an example embodiment of the digital building model generation process in accordance with an example embodiment;

FIG. 5 is a flow diagram of a fault detection and diagnosis (FDD) initiation process in accordance with an example embodiment;

FIG. 6 is a flow diagram of an FDD comparator initialisation process in accordance with an example embodiment;

FIG. 7A is a flow diagram of an FDD comparator process in accordance with an example embodiment;

FIG. 7B is a graph depicting the data streams being processed by the FDD comparator process in accordance with an example embodiment;

FIG. 8 is a flow diagram of an FDD strategy recommendation process in accordance with an example embodiment;

FIG. 9 is a flow diagram of an FDD recommender process in accordance with an example embodiment;

FIG. 10 is a flow diagram of an FDD augmentation process in accordance with an example embodiment;

FIG. 11 is a flow diagram of an FDD augmenter process in accordance with an example embodiment;

FIG. 12 is a flow diagram of an optimizer rollout planner process in accordance with an example embodiment;

FIG. 13 is a flow diagram of an optimizer planner process in accordance with an example embodiment;

FIG. 14 is a flow diagram of an optimizer rollout and verify process in accordance with an example embodiment;

FIG. 15 is a flow diagram of an optimizer rollout stage process in accordance with an example embodiment;

FIG. 16 is a flow diagram of an optimizer rollout strategy implementer process in accordance with an example embodiment;

FIG. 17A is a flow diagram of an optimizer engine process in accordance with an example embodiment;

FIG. 17B is a graph depicting the data streams being processed by the optimizer engine process for a fan in accordance with an example embodiment;

FIG. 18 is a flow diagram of a FDD verify stage process in accordance with an example embodiment;

FIG. 19 is a flow diagram of an FDD verifier process in accordance with an example embodiment;

FIG. 20 is a flow diagram of an FDD monitoring process in accordance with an example embodiment; and

FIG. 21 is a flow diagram of an FDD strategy monitor process in accordance with an example embodiment.

### DETAILED DESCRIPTION

### 1. System Overview

This disclosure relates to a BMS optimisation system and/or method. The BMS optimisation system comprises a cloud-based or remote server platform that co-operates with an onsite optimizer or controller that is in data communication with the existing building management system of a building. The cloud platform is configured to analyse the building, develop a building model, and recommend override control strategies for deploying to the existing BMS to optimize building behaviour for improved energy saving, climate control, and/or general building performance. The onsite optimizer engine is in data communication with the cloud platform, and operates to deploy the devised override control strategies to the existing BMS. In a configuration, the onsite optimizer is configured to deploy the override control strategies to the existing BMS control algorithms without re-writing the fundamental BMS control algorithms. For example, the override control strategies are configured to target particular configurable set points and/or control variables within the existing BMS control algorithms. The BMS optimisation system is able to be retrofitted or coupled to operate on or with or alongside the existing BMS of a building.

In one example embodiment, the onsite optimizer may be in data communication with the pre-existing BMS and/or controllers and/or building equipment instances via a BMS data communication protocol (e.g. BACnet or similar). In one example configuration, the optimizer may be configured to override the set points and control being implemented by the pre-existing BMS using a command prioritisation mechanism or command priority system. In one example, the command prioritisation mechanism or command priority system may be a feature of the BMS communication protocol (e.g. BACnet or similar), as will be explained in further detail later. In some embodiments, the pre-existing BMS may be agnostic to the overriding control of the optimizer.

A system architecture for the BMS optimisation system in one configuration and/or embodiment will now be described by way of example only. It will be appreciated that the components, engines, functions, and/or modules described may be integrated and/or distributed in different configurations or embodiments of the system. Additionally, not all components and functionality described are essential to the core operation of the system and aspects may be omitted, varied and/or substituted in different configurations and/or embodiments of the systems.

### 1.1 General System Architecture

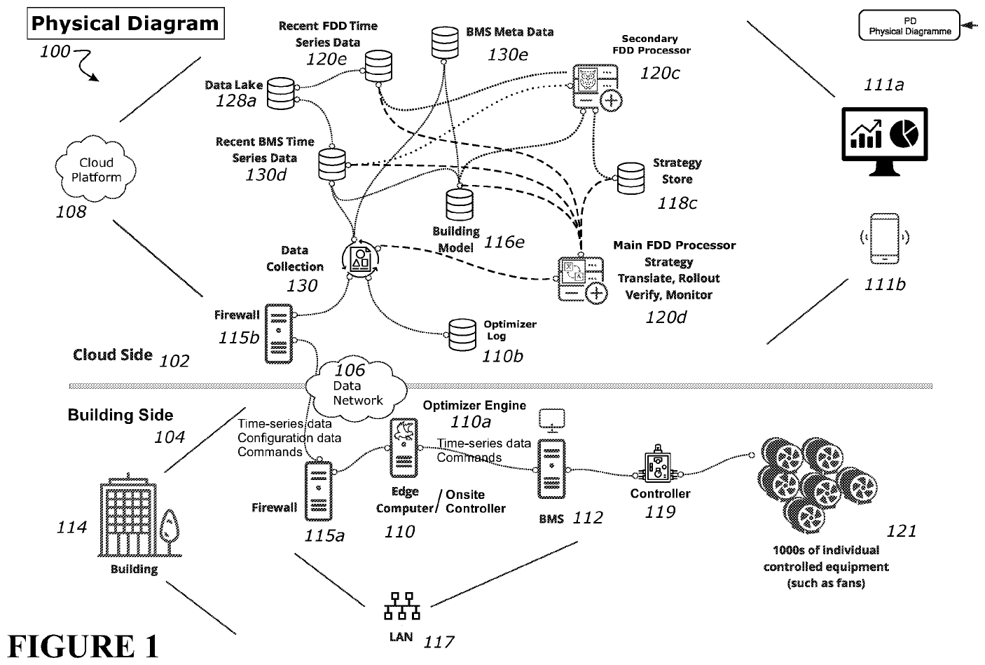

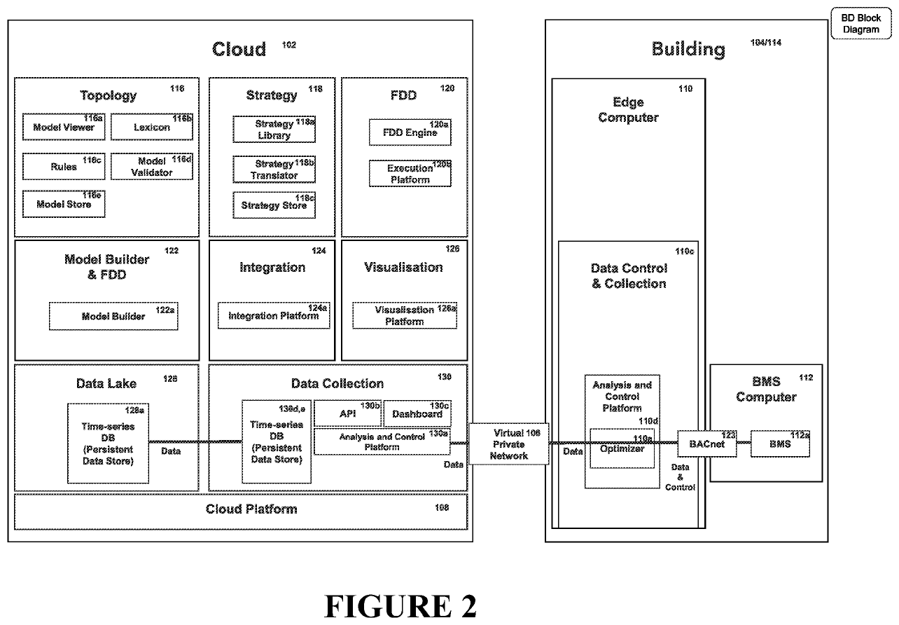

Referring to FIGS. 1 and 2, in this example configuration, the BMS optimisation system 100 comprises a cloud side 102 and a building side 104. The components on each side of the system communicate with each other over a data communication link or data network 106, such as the internet or similar.

In this example configuration, the BMS optimisation system comprises a Cloud platform or remote server 108 on the cloud side 102, and an onsite controller 110 on the building side 104. In this configuration, the onsite controller 110 is in data communication with the cloud platform 108 via the data network 106 and is also in data communication with the existing BMS 112 of the building 114. In this example configuration, the onsite controller 110 may be in the form of an edge computer or any other suitable electronic computing system, processor, or hardware that is configurable and programmable. Further detail on the main components and functionality of each side of the system will now be explained in further detail, for this example configuration.

In typical operation, the cloud platform 108 analyses the building and devises override control strategies, and the onsite controller 110 is configured to execute the devised control strategies by overriding the BMS 112 by manipulating and/or modifying BMS settings with low-level commands via a BMS communication protocol such as BACnet, as will be further explained. By way of example only, in some embodiments, the onsite controller 110 may be configured to periodically (e.g. every 5 minutes or some other higher or lower frequency) adjust or re-adjust set points of building components being controlled by the BMS, e.g. set points of hundreds or thousands of fans in the building, via low-level commands to the BMS, in accordance with the overriding optimized control strategies residing in the onsite controller 110. In one example configuration, the onsite controller may be configured to override the commands and/or set points being implemented or exerted by the control logic of the pre-existing BMS by generating and/or transmitting higher-priority commands and/or set points via the BMS communication protocol (e.g. BACnet or similar) to the BMS and/or controllers and/or equipment instances. The higher-priority commands and/or set points being in accordance with the override optimized control strategies.

### 1.2 Cloud Side

The cloud platform 108 comprises a number of modules or components of the BMS optimisation system 100, including processor modules and database storage for data collection and processing.

In this example configuration, the cloud platform 108 is hosted by a cloud service platform or provider, although it will be appreciated that the cloud platform 108 may be hosted by any proprietary or third-party hardware platform comprising one or more servers, databases, and/or processors.

An example configuration of one cloud configuration or architecture will be provided, but it will be appreciated that this may be varied or altered to deliver the functionality in different embodiments. The various software modules and components may comprise open-source software, proprietary software, or a combination of both. The hardware components may also be combined or distributed in different embodiments. Aspects of the system or platform, including software and/or hardware components, may be implemented by third party subscription services or may be proprietary components, or there may be a mixture of both.

In this configuration, the cloud platform 108 comprises a topology module 116, strategy module 118, fault detection and diagnostic (FDD) module 120, model builder module 122, integration module 124, visualisation module 126, data lake 128, and data collection module 130. As will be appreciated, the modules may communicate data and instructions between one or more other modules of the system. The primary functionality and configuration of each module will be described further below.

### Topology Module

The topology module 116 comprises software tools for creating a digital model of the systems (e.g. HVAC and other building components and operating parameters) of the building 114 being controlled by the BMS 112. The topology module comprises data in the form of modelling and correctness rules that enable the building models to be developed that are understood by the remaining modules during operation. The topology module 116 includes various software modules, tools, data, and/or components, which will be explained.

In this example configuration, the topology module 116 utilises a building modelling software framework. A model viewer 116a is provided as a software tool for viewing digital models of buildings. A lexicon 116b is provided as a library of valid model prototypes and constraint definitions.

In this example configuration, the topology module 116 comprises a rules module 116c that comprises one or more specific rules that validate specific models. A model validator software tool 116d is provided for automated validation of building models. A model store 116e is provided for storing models for multiple buildings.

### Strategy Module

The strategy module 118 comprises a library of optimised control strategies, high-level specification language, and translator to convert the high-level control strategies to low-level configuration strategies for processing by an FDD engine 120a of the cloud platform 108 and an optimizer engine 110a (e.g. processor, module, software, application, program, and/or hardware) of the onsite controller 110. The strategy module 118 includes various software modules, tools, data and/or components, which will be explained. The optimizer engine 110a may also be referred to as the ‘optimizer’ in this disclosure.

In this example configuration, the strategy module 118 comprises a strategy library 118a, strategy translator 118b, and strategy store 118c. The strategy library 118a comprises multiple control strategies that are configured for reducing energy consumption and/or otherwise optimizing operation of building systems (e.g. HVAC) run by the BMS 112 of a building 114. The strategy translator 118b is operable to translate high-level control strategy specifications from the strategy library 118a into low-level configuration data and/or instructions for the FDD engine 120a and/or optimizer engine 110a. In some embodiments, the strategy translator 118b translates the high-level control strategy specifications from the strategy library into low-level configuration data for the FDD engine 120a and/or optimizer engine 110a at least partly based on or as a function of the data stored in the model store 116e, recent BMS time series data 130d, and/or the data lake 128a. The strategy store 118c provides data storage for the control strategies and translations.

In one configuration, the strategy library 118a holds the ‘static’ information about control strategies, such as default control curves. The strategy store 118c contains the data representing the specific binding and customisation of the strategies specific to respective buildings, i.e. stores ‘instances’ of strategies.

### FDD Module

The FDD module 120 comprises one or more engines or modules that are configured to perform various functions. In one configuration, the FDD module 120 is configured or operable to analyse the building model of a building and recommend optimized control strategies from the strategy module 118 for deploying, via the onsite controller 110, to override one or more aspects of the control algorithms of the BMS 112. Additionally, or alternatively, the FDD module 120 is configured or operable to verify execution of the optimized control strategies by the onsite controller 110. Additionally, or alternatively, the FDD module 120 is configured or operable to continuously or periodically monitor operation of the onsite controller 110.

In this example configuration, the FDD module 120 comprises an FDD engine 120a (e.g. processor, module, software and/or hardware) that is configured or operable to execute the recommendation, verification and/or monitoring functions described above. In one example embodiment, the algorithms of the FDD engine 120a may be executed or implemented by an event-driven, serverless computing platform 120b or any other suitable processor or server configuration.

### Model Builder Module

The model builder module 122 comprises a model building software tool 122a for creating the building model 116e of the systems and components of the building 114 that are controlled by the BMS 12 and/or which are to be optimized by the BMS optimization system 100.

In this example configuration, the software tool 122a may automate at least part of generating a topology or digital building model of the building 114. In one embodiment, the model creation software tool may comprise one or more third-party software applications or tools.

In some embodiments, the model creation software tool 122a may comprise an application program or software tool or combination of application programs or software tools that are configured or operable to retrieve, access, read and/or retrieve one or more categories or sources of building data or information: (1) drawings of the current HVAC system(s) of the building, (2) functional system description(s), (3) manufacturer and model information for the components of the equipment instances of the HVAC or building systems (4), database(s) that map the manufacturer or model information onto archetypes, and/or (5) data scrapes of the points (e.g. set points) from the BMS. The model creation software tool is configured or operable to generate or create building model or models based on the combination of data from categories (1)-(5), for example. In one example configuration, the model creation software tool 122a is operable or configured to generate a Haystack or Brick model (both standards) for the HVAC system or systems of a building, and this defines or forms part of the digital building model. The model creation software tool 122a may also be configured or operable to map or create mapping data that links the set points of the BMS to specific types of equipment or equipment instances in the digital building model.

The model building software tool 122a is operable to automatically and/or manually generate one or more digital building models of the building 114. These digital building models are used by other components of the system, as will be explained. In a configuration, the model building software tool 122a may generate the digital model 116e of the building based at least partly on building operational data received from the building 114. The building operational data may be in the form of real-time data, e.g. time-series data representing the operation and/or status and/or functioning of equipment, components and/or systems within the building.

### Integration Module

The integration module 124 comprises a data integration software tool or platform 124a that connects or provides a data communication link between the model building software tool 122a and building operational data from the building 114. As will be further explained, the building operational data from the building 114 may be provided to the cloud platform 108 on the cloud side 102 via the onsite controller 110 on the building side 104 of the system. The onsite controller 110 receives and/or retrieves the building operational data from the BMS 112 of the building 114. In one embodiment, the integration module 124 is configured to connect the recent BMS time series data 130d, BMS meta data 130e, and digital building model 116e to the model builder 122.

In an example configuration, the data integration software tool 124a is configured to receive and/or retrieve the building operational data from the building 114 for storing in data storage. In one embodiment, the data collection module 130 is configured to receive data from the BMS module 112a of the BMS of the building 114, and stores that data in the databases associated with the data lake 128a, recent BMS time series data 130d, and BMS meta data 130e. The stored building operational data may then be accessed or retrieved by the model building software tool 122a for generating the digital building model.

In an embodiment, the data integration software tool 124a may comprise a data storage, data processing and/or retrieval platform or framework. In one example, the data integration software tool 124a may comprise the Apache Parquet platform. The platform may provide an open-source column-oriented data storage format or framework. In one example, the Apache Parquet platform provides an open-source column-oriented data storage format or framework. The building operational data stored and/or processed by the data integration software tool 124a may be in the form of time-series data for example.

In one example configuration shown, the integration module 124 is configured to receive or access the data from databases comprising the data lake 128a, recent BMS time series data 130d, and BMS meta data 130e, and then deposits the entire time series in a data repository or database in a format that is understood or readable by the model builder 122.

In another example configuration, the model builder 122 may utilise an API integration approach to access the required data. For example, the model builder 122 may be configured to make a series of calls or requests, via an API, to read or access the time-series data required, and/or other data such as BMS meta data.

### Visualisation Module

The visualisation module 126 comprises a visualisation software tool or platform 126a. The visualisation software tool 126a is operable to display or visualise one or more aspects of the operation of the building 114, BMS 112a, and/or BMS optimisation system 100. For example, data from the building 114, BMS 112, and/or BMS optimisation system 100 may be processed, analysed, and/or displayed in one or more charts, graphs, graphics, dashboards, and/or other data rendering formats. The data visualised may include, but is not limited to, building operational data, building digital models, and/or override control strategies. By way of example, the data visualised may include any or all of the data from the data lake 128a, recent BMS time series data 130d, BMS meta data 130e, and/or data from the FDD processor 120c.

In this example configuration, the visualisation software tool 126a may be the Grafana multi-platform open-source analytics and interactive visualisation application. In another example, the visualisation software tool 126a may comprise MS Power BI platform or any suitable toolset or platform that retrieves or accesses data, processes the data, analyses the data, and is operable to display graphs, charts, and/or reports relating to the data.

### Data Lake

The data lake module 128 comprises one or more databases 128a or data storage devices, e.g. hard drives or other electronic data storage. A data communication link is provided between the data lake 128 and the data collection module 130.

In this example configuration, the data lake module 128 comprises a data lake database 128a that is configured to store time-series data. In an embodiment, the data lake database 128a may be a time-series SQL database optimised for large volume time-series data, such as a TimeScale DB database for example.

### Data Collection Module

The data collection module 130 is configured to collect (e.g. retrieve or receive) and store real time building operational data from the building 114, and sends, transmits or feeds that data to the data lake module 128.

In one configuration, the data collection module 130 receives the building operational data and deposits this into the recent BMS time-series database 130d, with spill-over data going into the data lake 128a. In this configuration, database 130d may operate like a large buffer cache, with the data eventually being passed onto and stored in the data lake 128a. In one embodiment, the database 130d may be configured for faster data access relative to data lake 128a.

In this example configuration, the data collection module 130 comprises a data analysis and control platform 130a for accessing of and communicating data and instructions between the cloud platform 108 and the onsite controller 110 on the building side 104. In one example, the data analysis and control platform 130a may be the VOLTTRON™ platform or similar such platforms.

In this example, the data analysis and control platform 130a may be a small operating system built on top of Linux and Python, for example. In some configurations, the data analysis and control platform 130a may run specially crafted programs called “agents.” Agents communicate with one another and the outside world using tagged messages in a pub-sub (publish-subscribe) model. Agents post messages onto a message bus (essentially a queue), when the message reaches the head of the queue, agents that subscribe to the relevant tags are “woken up” and executed. The data platform messaging infrastructure supports federation (aggregation) of multiple software instances such that agents in different instances within the same network can communicate as if they are executing in the same instance. The core functionality of the data analysis and control platform 130a may be complemented by a library of agents that perform both general and building-specific functions. Building-specific agents include driver agents for protocols such as BACnet, MODBUS and OpenADR, and an agent that encapsulates EnergyPlus for testing other agents against simulated buildings. General purpose agents include a cloud communication agent, a “historian” for batching data, and an agent for downloading data from online weather services. These common “utility” agents can be combined with custom agents to implement a range of applications.

The data collection module 130 may comprise an Application Programming Interface (API) 130b for accessing the data analysis and control platform 130a, and a dashboard 130c that provides a human graphical user interface for accessing the data analysis and control platform 130a.

The data collection module 130 may comprise or be associated or in data communication with one or more data collection databases. In this configuration the data collection module comprises or is associated with databases 130d, 130e, and 128a, which are configured to receive and store building operational data. The building operational data may comprise recent time-series data received from the BMS 112 and/or meta data from the BMS, for example. In an embodiment, databases 130d, 128a may be a time-series SQL database optimised for large volume time-series data, such as a TimeScale DB database for example. The BMS meta data database 130e is typically static data relating to or identifying data points for reading data and/or configuring set points of building components. For example, each fan in the building may have a data point for reading its current speed, and another data point for setting its target speed. The BMS meta data for that fan identifies and names these data points, and may provide other data about them.

In this example configuration, the cloud platform 108 is in data communication with the onsite controller 110 of the building side 104 via a data network or data link 106. The data network or link may be any suitable data communication protocol or system or combinations of systems, and may include security and/or encryption components. In one example, the data network may comprise data communication over the internet. In one example, the data network may comprise data communication over an encrypted point-to-point data connection or a virtual private network (VPN) or a VPN service, such as Tailscale or similar for example. In other configurations, any suitable VPN may be used, but preferably one optimized for Internet of Things (IOT), e.g. using a peer-to-peer mesh network.

### Data Storage and Data Flow

As discussed above, the cloud platform 108 components described with reference to FIG. 2 is provided by way of example only. It will be appreciated that components may be combined, integrated, distributed or separated in various configurations and system architectures in alternative embodiments to provide the same functionality.

Referring to FIG. 1, further components of the cloud platform 108 on the cloud side 102 are depicted. As shown, the cloud platform may comprise or be in data communication with one or more databases or data storage devices for storing system data. It will be appreciated that the databases may be combined or separated in different configurations. In this example configuration, a dedicated database is provided for a specific set or type of data, but this is not essential to operation of the system.

As shown, various data flows across the data network 106 between the cloud platform 108 on the cloud side 102 and the onsite controller 110 on the building side 104. Examples of the data flow will be explained generally below.

Building operational data is transmitted from the building side 104 to the cloud platform 108 on the cloud side 102 of the system 100. The building operational data may be time-series data, static data, or any other data. Configuration data and commands (command data) are transmitted from the cloud platform 108 to the onsite controller 110 on the building side. In this example configuration, the data (building operational data, configuration data, and commands) flows via a firewall system or device 115a, 115b on the building side 104 and/or cloud side 102. By way of example, a firewall 115a may exist on the building side 104 in the data flow path between the data network 106 and onsite controller 110, and a firewall 115b may exist on the cloud side 102 in the data flow path between the data network 106 and the data collection module 130.

The configuration data or strategy configuration data provided from the cloud platform 108 to the onsite controller 110 may express to the optimizer 110a the control strategies to execute on the BMS 112a, how to execute the strategies and/or other configuration parameters. Management data (e.g. including any permission and/or authorisation data) may also be provided to the optimizer 110a of the onsite controller 110 to enable the various building components inside the building 114 to be observed and/or controlled in order to execute the control strategies and/or manage the building components.

The time-series data sent from the onsite controller 110 on the building side 104 to the cloud platform 108 may include various sub-types. One sub-type of the time-series data may capture the state of the BMS, building and/or building components as time-series point values. Another sub-type of the time-series data is time-series data that captures the series of commands issued by the onsite controller 110 to the BMS 112a.

In the example configuration, the cloud platform 108 may also provide data representing operational commands for the optimizer 110a of the onsite controller 110. Data in the form of code for the optimizer 110a may also be provided from the cloud platform 108 to the onsite controller 110. The code may be provided via a cyber secure protocol used to update and/or replaces code in the onsite controller 110, which is an edge computer in the example configuration. The optimizer code could be at any level of the stack, including from low level code up to base code and configuration for the optimizer.

On the cloud side 102, the data flows via the data collection module 130 of the cloud platform 108. For example, the time-series building operational data transmitted from the onsite controller 110 via the firewall 115 and data network 106 is received in the data collection module 130. The configuration data and commands transmitted from the data collection module 130 via the data network 106 and firewall 115 is received by the onsite controller 110.

In this embodiment, the data collection module 130 comprises one or more associated or accessible data collection databases 130d, 130e, and 128a. In this embodiment, the data collection database 130d is configured to receive and store recent time-series data transmitted from or provided by the BMS 112. The data collection database 130e is configured to receive and store BMS meta data, in this embodiment. The data lake 128a is configured to store more permanently BMS time-series data passed on from database 130d, as explained above.

The data collection database 130d of the data collection module 130 is in data communication with the data lake database 128a of the data lake module 128, and feeds the data lake database 128a with time-series data representing the building operational data. In one configuration, the data collection database 130d is a hard drive or other electronic storage device. Data movement or transmission is co-ordinated by the data collection module 130.

The building model database 116e of the topology module 116 is in data communication with the data collection databases 130d, 130e, and is configured to retrieve and/or receive BMS time-series data and BMS meta data from these databases. In this example embodiment, building model database 116e is a hard drive or electronic data storage device for storing building models. In this embodiment, the digital building models stored in building model database 116e are read, retrieved or accessed by strategy translator 118b of the strategy module 118 for example, as previously explained. The digital building models are written to and/or stored in the building model database 116e by the model builder software tool 122a, for example.

In this example configuration, the FDD engine 120a of the FDD module 120 comprises two main sub-modules 120c, 120d. The first sub-module is a main FDD processor 120d, and the second sub-module is a secondary FDD processor 120c. In this embodiment, the main FDD processor 120d is configured to handle higher-level functions such as selecting and/or recommending optimised control strategies, translating the control strategies to lower-level instructions, rollout of the optimised control strategies, verification of the rolled-out optimised control strategies, and monitoring of the optimised control strategies (whether continuous, periodic, and/or ad hoc). The secondary FDD processor 120c is configured to handle lower-level operations or functions.

By way of example, in one configuration, the main FDD processor 120d is operable to run a recommendation engine to recommend control strategies to optimize operation of the BMS. During the recommendation process, the main FDD processor 120d is configured to use the digital building model data from the building model database 116e to determine how to configure the secondary FDD processor 120c to carry out lower-level data processing, such as analysing the BMS time-series data streams from database 130d and identifying optimisation opportunities. During this process, the secondary FDD processor 120c generates its own set of FDD time-series data that comprises data indicative of points in time where particular building components or equipment have opportunities for optimisation, and this data is stored in FDD database 120e.

Once the system 100 is configured to use a particular control strategy based on the recommendations from the recommendation engine, the main FDD processor 120d is configured to translate the high-level control strategy into low-level configuration files or data that can be transmitted (in a rollout function of the main FDD processor 120d) to the optimizer 110a of the onsite controller 110 for execution. The main FDD processor 120d performs the translation based at least partly on the building model from the building model database 116e, the FDD time-series data 120e generated by the secondary FDD processor, and recent BMS time-series data 130d.

During the rollout phase of the optimised control strategies to the optimizer 110a, the main FDD processor 120d configures what specific devices, components or equipment of the building are placed under control of the optimizer 110a and when. For example, in stage 1 of the rollout, the main FDD processor may decide to put only 10 of the 1000 building fans under control of an optimized control strategy S executed by optimizer 110a.

The main FDD processor 120d is also configured to execute a verify function to ensure the rolled-out control strategies are operating as expected. During the verify function or process, the main FDD processor 120d generates new configuration data or files for the secondary FDD processor 120c so that it is very sensitive to deviations between the actual building behaviour and that expected based on the optimized control strategies being executed by the optimizer 110a.

The main FDD processor 120d is also configured to execute a monitor function to monitor the ongoing operation of the optimizer 110a after the rollout and verification stages. During the monitory function or process, the main FDD processor 120d generates new configuration data or files for the secondary FDD processor 120c so that it has a lower sensitivity (compared to the verify function) to deviations between the actual building behaviour and that expected based on the optimized control strategies being executed by the optimizer 110a. The lower sensitivity during the monitor function is to reduce the number of alerts or alarms generated, so as to not overload administrators of the system with non-essential alerts or alarms during the ongoing monitoring of the BMS optimisation system 100.

As discussed above, the FDD module 120 comprises an associated or accessible FDD database 120e. In this embodiment, the FDD database 120e is in data communication with the secondary FDD processor 120c and main FDD processor 120d of the FDD engine 120a. In this example configuration, the FDD database 120e stores recent FDD time-series data generated by the secondary FDD processor 120c, as explained above.

In one configuration, the secondary FDD processor 120c is configured to operate recursively with the data in the FDD time-series database 120e. For example, a “thread” T1 in secondary FDD processor 120c may be processing the fan speed time-series TS1 data for Fan F1, and storing a new time-series in FDD database 120e called SQ1 that indicates how good a match Strategy S is for Fan F1, at every point in time in series TS1. Assuming this process is replicated for all 1000 fans in the building, there is then another “thread” Z in secondary FDD processor 120c that receives or retrieves all 1000 copies of SQ1, and generates a new series ZSQ1 that indicates how good a match Strategy S is for this building taking into account things like the number of fans with a good match.

The secondary FDD processor 120c of the FDD engine 120a is in data communication with the building model database (model store) 116e, data collection database 130d, and strategy store database (strategy store) 118c. In particular, the secondary FDD processor 120c is configured to receive and/or retrieve building model data, recent BMS time-series data, and control strategy data from the respective databases 116e, 130d, and 118c. As explained above, the secondary FDD processor 120c is also in data communication with the FDD time-series database 120e.

The main FDD processor 120d of the FDD engine 120a is also in data communication with the building model database (model store) 116e, data collection database 130d, and strategy store database (strategy store) 118c. In particular, the main FDD processor 120d is configured to receive and/or retrieve building model data, recent BMS time-series data, and control strategy data from the respective databases 116e, 130d, and 118c. The main FDD processor 120d is also in data communication with the data collection module 130, and the FDD time-series database 120e.

In this example configuration, the cloud platform 108 on the cloud side 102 also comprises an optimizer log database 110b. The optimizer log database 110b is configured to receive and store log data transmitted from the onsite controller 110 on the building side 104 of the system 100. In one example, the optimizer log data records a trace of the logic of the optimizer while it is executing its control over the BMS 112a.

In this example configuration, the cloud platform 108 on the cloud side 102 of the system 100 may further comprise one or more user interface devices 111a, 111b that are operable by a user or users (e.g. system administrator, modeler, energy analyst, strategist, for example) to access, control, monitor and/or operate the system. As will be appreciated, the cloud platform 108 may be accessible by a range of suitable electronic user interfaces, such as computers, tablets, smartphones, or any other electronic device or system typically comprising a processor, memory, display, and user input/output device (e.g. keyboard, mouse, touch-screen). In some embodiments, a dedicated software application program or programs may be installed on the user interface devices for accessing and operating the system 100. In some embodiments, the user interface devices may access and operate the system 100 via a website interface hosted by a web server of, associated, or connected to the cloud platform 108.

The user interface devices may be operated to access, configure, operate and/or monitor the system. In some embodiments, the user interface devices may be operable to display charts, graphs, plots, tables and/or other formats or renderings of one or more aspects of the system data described above. The user interface devices may also be operable to configure system settings or parameters.

### 1.3 Building Side

The building side 104 of the system 100 comprises the onsite controller 110 that is located onsite in the building 114 and is in data communication or operatively connected to the existing BMS 112 of the building 114. As explained earlier, the onsite controller 110 receives building operational data (e.g. time-series data) from the BMS 112, and relays that to the cloud platform 108 via the firewalls 115a,115b and data network 106. The onsite controller 110 also receives configuration data and commands from the cloud platform 108 via the data network 106 and firewalls 115a,115b.

In this example implementation of the BMS optimisation system 100, the optimizer 110a is shown operating in an onsite controller 110 in the form of an edge computer, and the BMS software 112a is shown operating in a dedicated BMS computer or system 112. However, in alternative embodiments, it will be appreciated that either or both of the optimizer 110a and BMS software 112a may be virtualised, and may run or operate in the same computer or system. The computer or system operating or executing the optimizer 110a and BMS software 112a need not necessarily be a dedicated machine or computer for those operations or applications, and may provide other functionality or be a general purpose computing system. Regardless of the configuration, the optimizer 110a (which may be a software program or application) and the BMS software or application 112a are in data communication, whether in the same computing system or different computing systems.

The optimizer engine 110a of the onsite controller 110 is configured to control and/or override one or more aspects of the BMS control logic based on the received commands representing the optimized override control strategies, to optimize control of one or more aspects of the building equipment and/or components (e.g. HVAC system and/or components). In one example configuration, the onsite controller 110 may generate commands and/or set points in accordance with the optimized override control strategies to control building equipment instances and/or components, and may override one or more aspects of the commands, set points and/or control being exerted by the pre-existing BMS control logic via use of a command prioritisation mechanism. For example, the onsite controller 110 may send or generate commands and/or set points for an equipment instance that have a higher priority than the commands issued by the pre-existing BMS.

In this example configuration, the firewall 115a, onsite controller 110, and BMS 112 on the building side 104 of the system are in data communication via a local data connection network such as, but not limited to, any one or more of a LAN, WLAN, modbus or other data communications protocol, or point-to-point data communications links, or the like as shown at 117.

In this embodiment, the building 114 comprises a BMS 112 that is operatively connected to one or more building controllers 119. In some embodiments, the BMS software 112a of the BMS 112 and the building controllers 119 may be software stacks or applications that may run in separate computing systems or the same computing system or computer. As will be appreciated, the building controller(s) 119 are configured to operate and control multiple individual building components and equipment 121 in accordance with commands and/or control instructions (e.g. temperature set points, fan speeds) provided by the BMS 112. As will be appreciated, the building equipment and components 121 will vary in number, specification, and configuration depending on the building and systems operating in the building. There may be hundreds or thousands or tens of thousands of components being controlled by the BMS 112. By way of example, typical components and equipment controlled by and/or in communication with the BMS 112 include, but are not limited to, fans, valves, boilers, lights, sensors, chillers, economizers, pressure controls, set points.

By way of further explanation, in this example configuration the controller 119 may be configured to ‘translates’ higher-level commands into low-level actions to implement those commands. For example, the BMS might send a command to ‘change the speed of fan F to be 90% of maximum’. The controller 119 might translate that into low-level voltage level that is required to get the target motor speed that ultimately translates into the fan F running at the required speed. The controller 119 may also be responsible for ‘ramping’ commanded changes up and/or down to avoid damage to electrical and mechanical components. In the context of fan control, the controller 119 is typically using ‘voltage control’ as speed control for the motor-driven fans, i.e. controlling the voltage applied across the motor terminals of the fan.

Referring to FIG. 2, further detail of the modules or components on the building side of the BMS optimization system 100 will be described, by way of example. As discussed, the BMS optimization system 100 comprises an onsite controller 110 that is installed onsite at the building 114 and which is operatively connected or otherwise in data communication with the pre-existing BMS 112 system. The pre-existing BMS 112 in the building 114 may be any typical BMS from a range of manufacturers or other vendor proprietary control system.

In this example embodiment, the onsite controller 110 comprises an edge computer or other distributed computing system. In other embodiments, the onsite controller may be any other suitable form of hardware device or system with a processor and memory, and which has data communication capabilities with the BMS 112 and cloud platform 108. The edge computer of the onsite controller 110 is installed or located onsite at or near the building on the building side of the 104 of the system. The edge computer of the onsite controller 110 is in data communication with the BMS 112 of the building 104 and the cloud platform 108 via the firewalls 115a, 115b and data network 106. The edge computer of the onsite controller 110 is capable of real-time processing of data flowing (e.g. transmitted and/or received) between the cloud platform 108 and the BMS 112.

In this embodiment, the edge computer of the onsite controller 110 comprises a data control and collection module 110c. The data control and collection module 110c comprises an analysis and control platform 110d for analysing and controlling building systems and building automation systems. In this example, the analysis and control platform 110d may comprise a VOLTTRON platform or any other suitable platform or system. In this example configuration, the analysis and control platform 110d comprises adaptor software or communication modules for data communication with the BMS software 112a of the BMS 112 over a BMS communication protocol. In this embodiment, the BMS communication protocol is the BACnet protocol 123, which is a protocol for reading data from and/or commanding a BMS.

In this example embodiment, the onsite controller 110 is able to execute the optimized control strategies in preference or in priority to the native or pre-existing control logic of the pre-existing BMS 112. In one example configuration, the onsite controller 110 is configured to override the pre-existing BMS 112 using a command prioritisation mechanism or system of the BMS communication protocol (e.g. BACnet or similar). For example, the onsite controller 110 may control equipment and components of the building (e.g. HVAC components) by commands and/or instructions tagged with a higher priority than those issued natively by the pre-existing BMS 112. By way of example, in the case of a BACnet BMS communication protocol, the commands issued by the onsite controller 110 over BACnet to the BMS and/or controllers and/or building equipment may comprise a write property value request (e.g. set point for the equipment instance such as fan speed set point in the case of a fan) having an associated command priority setting or level. When a command is sent, it takes effect only if it is the highest command priority currently in the command priority array for that property of the equipment instance (e.g. BACnet commandable object or BACnet device).

In one example configuration, the onsite controller 110 commands are at least issued or tagged with a higher priority than the native commands of the pre-existing BMS 112. In another example configuration, the onsite controller 110 commands are issued or tagged with a priority that is higher than the native commands of the pre-existing BMS 112 but lower priority than a predetermined or configurable safety priority level or setting (e.g. the priority of manual operator commands may have the highest priority level from a safety viewpoint). As will be appreciated, the equipment and components of the building respond to the higher priority instructions in preference to standard or native priority command instructions of the pre-existing BMS 112. As such, the onsite controller 110 may exert its optimized control strategies in preference or priority to the native control logic of the pre-existing BMS 112.

In some embodiments, the system is configured such that the pre-existing BMS 112 may be agnostic or unaware (or without knowledge) of the overriding control of the onsite controller 110. In particular, the pre-existing BMS may continue to operate in accordance with its native control logic (e.g. control strategies) and send commands for controlling the building equipment, but at least a portion of those commands and/or control strategies may be overridden by onsite controller 110 commands (based on optimized control strategies) having a higher priority. In some such embodiments, if the onsite controller 110 goes offline, is shutdown, faults or otherwise fails (e.g. data connection loss), the pre-existing BMS seamlessly resumes or exerts control as its native commands to the building equipment are no longer overridden by the offline onsite controller 110. With this configuration, the onsite controller can be seamlessly installed to optimize the building behaviour by exerting specific control to implement optimized control strategies without needing to re-code or modify the native control logic of the pre-existing BMS. The native control logic of the pre-existing BMS can remain and can co-exist with the control being exerted by the onsite controller. In some instances, the onsite controller may exert control and override only certain or some aspects of the building behaviour, leaving the pre-existing BMS to continue to exert control over the remaining aspects of building behaviour in accordance with its native control logic.

In alternative embodiments, it will be appreciated that the edge computer of the onsite controller 110 may be adapted or configured for data communication (e.g. reading data and sending commands) with the BMS software 112a over any other BMS communication protocol, depending on the type of BMS 112 in the building 114, including but not limited to LonWorks, Modbus, KNX for example.

As shown, the BMS computer or system 112 of a building 114 typically comprises one or more BMS software components or modules 112a that monitor and control the equipment and components of the building (e.g. HVAC components) in accordance with preconfigured BMS control strategies or logic. It will be appreciated that the BMS module 112a may operate within the BMS computer 112 as shown, or in alternative configurations may be a virtualised module or engine operating in a separate computer, system, device or processor that is not dedicated to the BMS computer 112, and the embodiments described can apply to either configuration.

The edge computer of the onsite controller 110 comprises an optimizer engine 110a that is configured to communicate with the BMS software module 112a of the BMS 112 via the BACnet. The optimizer engine 110a is configured to send commands to the BMS 112a and/or controllers and/or equipment that override one or more aspects (e.g. set points for example) of the pre-configured or existing behaviour or control logic of the BMS 112a based on the optimised override control strategies devised in and received from the cloud platform 108 for the building 114. As explained above, the optimizer engine 110a may be configured to utilise a command prioritisation mechanism of the BMS communication protocol (e.g. BACnet) to override with higher priority the native commands generated by the pre-existing BMS 112a. As such, the optimizer engine may selectively exert the one or more optimized control strategies in preference or priority to the native control logic being executed on the pre-existing BMS 112a. The optimized override control strategies devised or generated in the cloud platform 108 are configured to reduce, minimise or otherwise optimise energy and/or power usage of the building equipment 121, and/or may also prolong the life of the building equipment 121 and/or reduce maintenance and repair costs.

### 1.4 Installation of BMS Optimisation System

In an embodiment, the BMS optimisation system 110 may be deployed or installed into any building 114 with an existing BMS 112 or BMS software 112a. In one configuration, the installation involves installing the onsite controller 110 at or in the building 114 and operatively connecting the onsite controller for data communication with the BMS 112 and the cloud platform 108. In another configuration, the optimizer engine 110a may be installed to execute on any suitable computing system that is in data communication with the BMS software 112a, or the optimizer engine 110a may be installed to operate in the same computing system as the BMS software 112a.

### 2. Example System

### 2.1 General Functionality

An embodiment of the function and operation of the BMS optimisation system 100 described above will now be provided by way of further example.

### Connect, Model, Specify

The BMS optimisation system 100 comprises an onsite controller 110 that is connected to the existing BMS 112 of the building 114 to collect and analyse vast amounts of building operational data. The system 100 then builds or generates a digital model of the building. The FDD module 120 in the cloud platform 108 is configured to analyse the building model and recommend control strategies from the strategy library 118a that will reduce energy consumption in the building. The recommended override control strategies selected are then translated or converted into an override control specification that represents the override control strategies.

In one configuration, the main FDD processor 120d of the FDD module 120 may use the digital model in the building model database 116e, in combination with administrator or engineer control inputs, to determine the scope covered by the selected control strategies to deploy. For example, the scope may determine that only a portion (e.g. 700) of the say 1000 fans in the building are to be configured to be controlled in accordance with the selected optimized control strategy. This scope may be determined by the main FDD processor 120d based on a number of factors and/or considerations such as, but not limited to, expected energy savings, ‘off limit’ areas, and suitability of the specific fans to be controlled. As previously discussed, the main FDD processor 120d is also responsible for determining how to roll-out the control strategies to the optimizer 110a. For example, typically the rollout is progressively to different areas of the building, rather than the entire building at once, although this is an option in some applications. The rollout plan is generated as part of the specification process.

In this example configuration, the BMS optimisation system 100 generates, receives or builds the digital model of the building. The digital building model may be built entirely or at least partially automatically based on building data extracted from the building or BMS or other input data, and/or may be built or generated manually or at least partly manually. In some embodiments, aspects of the building model may be created or generated automatically and other aspects may be created or generated manually or with user input or control of the model builder 122. In other embodiments, a pre-existing digital building model of the building 114 may be received or retrieved by the BMS optimisation system to use in data processing.

As discussed, the BMS optimisation system 100 comprises a strategy library 118a of control strategies for overriding BMS behaviour or control logic. The FDD module 120 is configured or operable to analyse the digital building model and recommend selected override control strategies from the strategy library 118a based on analysing the digital building model and current building behaviour. The recommended control strategies determined in the FDD module 120 of the cloud platform 108 are then translated, converted or transformed into configuration data or override control specification for automatically configuring the optimizer engine 110a of the onsite controller 110 coupled to the BMS 112 of the building 114. The onsite controller is then configured to execute the override control strategies by overriding one or more aspects of the BMS behaviour during operation. As discussed above, in one example configuration the onsite controller may override the native control of the BMS by issuing commands or messages (in accordance with the override control strategies) that have higher priority than the native commands of the BMS.

### Control

As discussed above, the override control specification is then deployed or transmitted from the cloud platform 108 to the optimizer engine 110a of the onsite controller 110 at the building. The override control specification configures the optimizer engine 110a to progressively exert control over one or more aspects of the control logic of the existing BMS 112 to optimise energy usage while still maintaining and/or delivering the same overall building functionality (e.g. heating and cooling for example in a building HVAC system). In this example configuration, the optimizer engine 110a of the onsite controller 110 is able to override specific behaviours of the existing BMS 112 without requiring modification or updating of the core control logic or software of the BMS. By way of example, the optimizer engine 110a may override set points within the BMS 112a for specific building components in the building, to optimize and/or improve their behaviour relative to the original or native control logic and set points exerted by the BMS 112a. As explained above, the optimizer engine 110a may issue or send commands (e.g. set points) to control the building equipment in accordance with the optimized control strategies. In this example, the optimizer engine 110a may override the control or aspects of the control of the BMS 112a based on command prioritisation mechanism (e.g. command priority array of BACnet). For example, the commands and control generated by the optimizer engine 110a may be issued with a higher priority than the native commands and control of the BMS 112a. This enables the optimizer engine 110a to override certain control logic of the BMS and exert control over one or more aspects of the building behaviour based on the optimized control strategies.

By way of example only, a typical BMS 112 may operate a water boiler at a fixed temperature that is sufficient for the maximum heat demand for the building 114. After installation of the BMS optimization system 110, the BMS behaviour is overridden such that the boiler operates or runs at an optimal temperature that is required for the real-time heating demand, and this reduces the energy consumption of the boiler.

### Verify

The FDD module 120 in the cloud platform 108 is configured to carry out one or more functions. In this example, the FDD module 120 is configured to monitor and verify that the onsite controller 110 is working in accordance with the override control specification. As will be explained in further detail later, the FDD module 120 is configured to automatically verify in real-time that the optimizer engine 110a of the onsite controller 110 is performing as expected. In one configuration, the FDD module uses a statistical algorithm to verify operation of the optimizer engine 110a during the initial rollout or installation of the system 100.

### Monitor

The optimizer engine 110a in the onsite controller 110 is configured to implement and/or execute the override control specification or override control strategies via command or control data sent to the BMS 112. As previously explained, in one example configuration, the optimizer engine 110a may issue command and control data over the BMS communication protocol (e.g. BACnet) at a higher priority for execution compared to the native command and control of the BMS 112. The FDD module 120 in the cloud platform 108 is configured to receive and analyse (typically continuously, but may be periodically or ad hoc) building operational data to monitor the optimizer engine 110a and building for proper operation, for long-term monitoring and alerting. In this embodiment, the monitor function or process carried out by the FDD module 120 may operate to a lower sensitivity to error compared to the verify function or process, such that the monitoring process generates less fault alarms or alerts relative to the verify function or process. For example, the monitor function of the FDD module 120 may have a higher tolerance configuration for error (e.g. between actual behaviour and expected behaviour) compared to the verify function or process, which may have a lower tolerance configuration for error. The verify function is used following the rollout of the optimizer engine to the building, and therefore is configured to pick up more errors and faults such that they can be addressed in the rollout phase. The monitor function is used during normal operation following rollout, and is less sensitive to error so as to not generate an overwhelming number of alerts or fault warnings for the system administrator.

### 2.2 System Operation Example

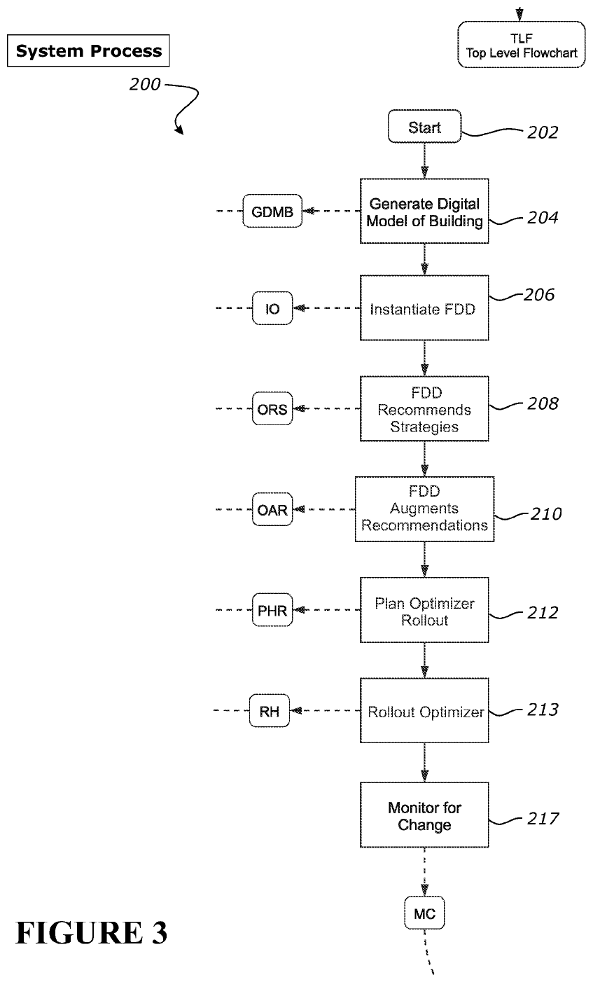

A more detailed example of the operation, configuration, and functionality of the BMS optimisation system 100 will now be described with reference to the flow diagrams of FIGS. 3-21.

### System Process Overview

Referring to FIG. 3, a top-level flow diagram of the system process 200 is depicted. The system process 200 comprises the main stages and functions that operate during commissioning and operation of the BMS optimisation system 100. In this example configuration, some stages and functions operate sequentially, and other stages may operate concurrently, as will be further described below. However, in some aspects, one or more of the processes or sub-routines or algorithms while described sequentially, may operate concurrently depending on processing resources and configurations. This example is one embodiment of the process flow, and it will be appreciated that not all stages may be essential in alternative embodiments.

The first stage of the system process 200 after starting 202 is the model builder module 122 generating and/or receiving a digital model of the building as shown at stage 204. Once the digital building model is generated, the system process initiates the FDD module 120 at shown at stage 206. Following this, the FDD module 120 (e.g. secondary FDD processor 120c) analyses the building data (e.g. BMS time-series data 130d) and digital building model (e.g. digital model 116e), and recommends override control strategies as shown at stage 208. The FDD module 120 (e.g. main FDD processor 120d) then augments the selected recommended override control strategies at stage 210. Rollout of the override control strategies generated by the FDD module 120 (e.g. main FDD processor 120d) in the cloud platform 108 is then configured or planned at stage 212 by the FDD module 120 (e.g. main FDD processor 120d). Following this, the override control strategies are deployed, rolled out, or transmitted to the optimizer engine 110a of the onsite controller 110, which then executes the override control strategies on the existing BMS 112 of the building 114, as shown at stage 213. The system process 200 then concludes by monitoring the operation of the system as shown at stage 217. Each stage will be described in further detail below.

### Digital Building Model

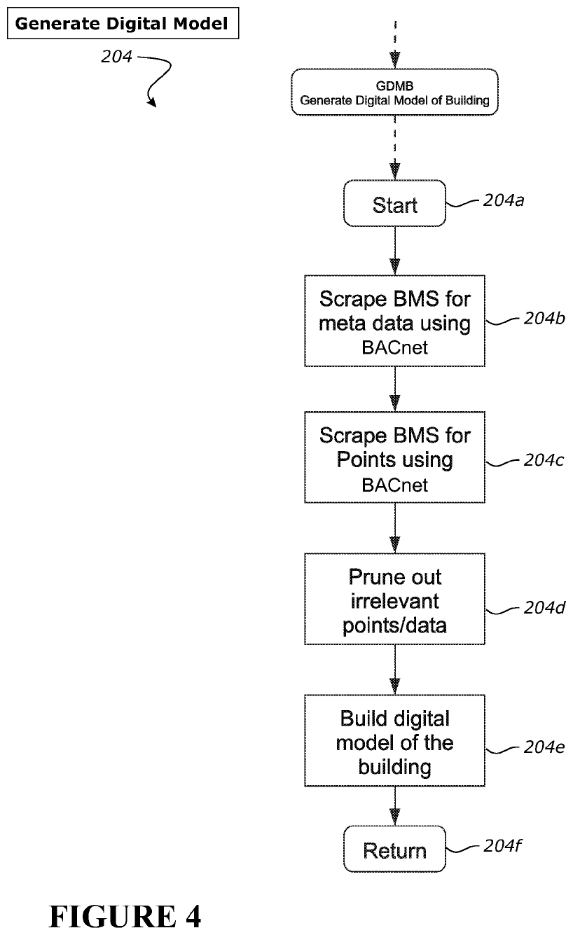

Generating the digital building model at stage 204 in the system process 200 will now be further explained with reference to FIG. 4. The digital building model generation process 204 is carried out primarily by the topology module 116 and model builder module 122. In this example configuration, steps 204a-204d are carried out by the analysis and control platform 110d and other components of the onsite controller 110, and step 204e is carried out by the model builder 122 of the cloud platform 108. These components of the system and configured or operable to read and/or write the digital building model in model store 116e.

The digital building model generation process 204 starts 204a by scraping (e.g. receiving, accessing and/or retrieving) building meta data from the BMS 112 of the building via the onsite controller 110 and BACnet data connection and protocol 123 to the BMS 112 as shown at step 204b. Next, the BMS 112 is scraped for points using the BACnet data connection and protocol as shown at step 204c. The meta data and points are then analysed and irrelevant meta data and points are filtered or pruned out of the data sets as shown at step 204d. Finally, the digital model of the building is generated based on the filtered meta data and points extracted from the BMS 112 as shown at 204e, and the process then returns 204f to the main system process flow 200.

In some configurations, the BMS building meta data may comprise ‘point names’ identifying or associated with equipment instances in the building. The ‘point names’ may be vendor proprietary and/or installer specific, depending on the BMS and/or building. In some examples, the ‘point names’ may be assigned by convention. In some configurations the ‘point name’ may encode or provide information on the type and/or location of the equipment instance.

By way of further explanation, examples of ‘points’ in the BMS that are scraped and/or identified will be described. The ‘points’ may be data points for example. The points may be read only, write only, or read and write. In one example, there may be a room 916on floor 9 of a building. Room 916 may have a sensor that reads the temperature in that room. The sensor is considered an equipment “instance” of the building. The BMS may have a ‘point’ that represent the ability to read the temperature of that sensor. A particular piece of equipment or equipment instance might have multiple points. In another example, the equipment instance might be a thermostat in a room. There might be a point to represent the ability to read the temperature as reported by the temperature sensor in that thermostat. There might be another point to represent the ability to read where the user has set the “dial” to represent the desired target temperature. There might be another point that can be written to, to allow overriding that target temperature. In another example, for an equipment instance that is a fan, there might be a point to set the target fan speed, and another point to read the current fan speed, for example.

In some embodiments, the model builder 122 uses the scraped points, meta data, and one or more additional databases to generate the digital building model. As discussed, the model builder or application 122 may operate automatically, may operate with automatic aspects and manually controlled inputs and aspects, or may be entirely manually operable by a user to generate the digital building model. By way of example, the one or more additional databases or data used to generate the digital building model may include building equipment information or specifications in the meta data, the building's mechanical drawings, and/or the building's HVAC functional specification.

The additional databases or data may be utilised by the model builder 122 to ascertain the exact type of building equipment, how it behaves, and how it is typically connected to other equipment, to facilitate creating a functional and detailed digital building model. In some cases, templates may be used to automate aspects of populating the digital building model. The process of generating the digital building model may be a mix of automation and manual inputs or control, in some embodiments. The ratio of automation and manual input in the process of generating each digital building model may vary depending on various factors. The level of functional detail in the digital building model may also vary depending on various factors. For example, the functional detail may vary from minimum in Haystack to far more specific and accurate in Brick, or may include physics-based and supporting energy calculations.

### FDD Module Initiation Process

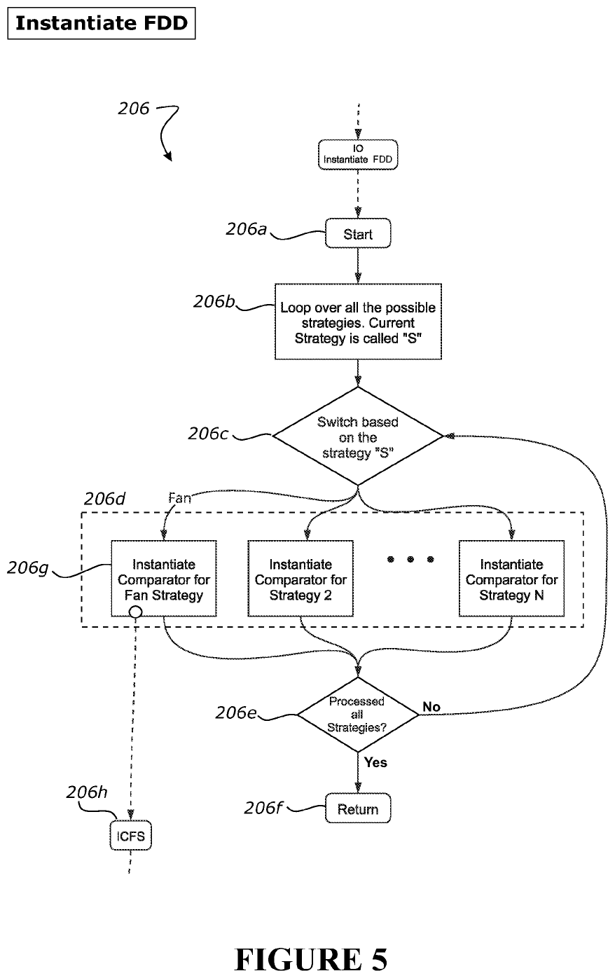

Following the generation of the digital building model 204, the system process 200 moves to the step of initiating the FDD module 120, and the FDD module initiation process 206 will be described by way of example with reference to FIGS. 5-7B.

Referring to FIG. 5, the FDD module initiation process 206 starts at 206a by looping over all possible control strategies in the strategy library 118a as shown at 206b with a comparator process. The strategy library 118a may comprises multiple different control strategies (e.g. Strategy 1, Strategy 2, . . . Strategy N, where N is the last strategy in the library) for different component-types (e.g. fans) 121 of the building 114. In some embodiments, the strategies may be in categories based on the type of equipment or components they relate to. There may be one or more strategies in each strategy category or for each component-type. By way of example, there may be a ‘fan strategy category’ comprising one or more fan control strategies, and a ‘boiler strategy category’ comprising one or more boiler control strategies, etc.

The process 206 cycles or loops through and processes each control strategy 206d with a comparator process to generate output diagnosis data representing the processed and/or analysed control strategies. The processing cycles or switches between the different control strategies at 206c until all the control strategies are processed as shown at decision 206e. In particular, after processing a control strategy, the process 206 determines at decision 206e whether there are any further control strategies to process. If there are, the process returns to 206c to switch to the next control strategy to process. If all control strategies have been processed, the process returns to the main process flow 200 as shown at 206f.

By way of example, the processing of a first example control strategy will be described, and this process is similar for each control strategy. In this example, the first control strategy to be processed is a ‘fan strategy’ 206g. The processing of the fan strategy 206g spawns or initiates a FDD comparator initialisation process as shown at 206h.

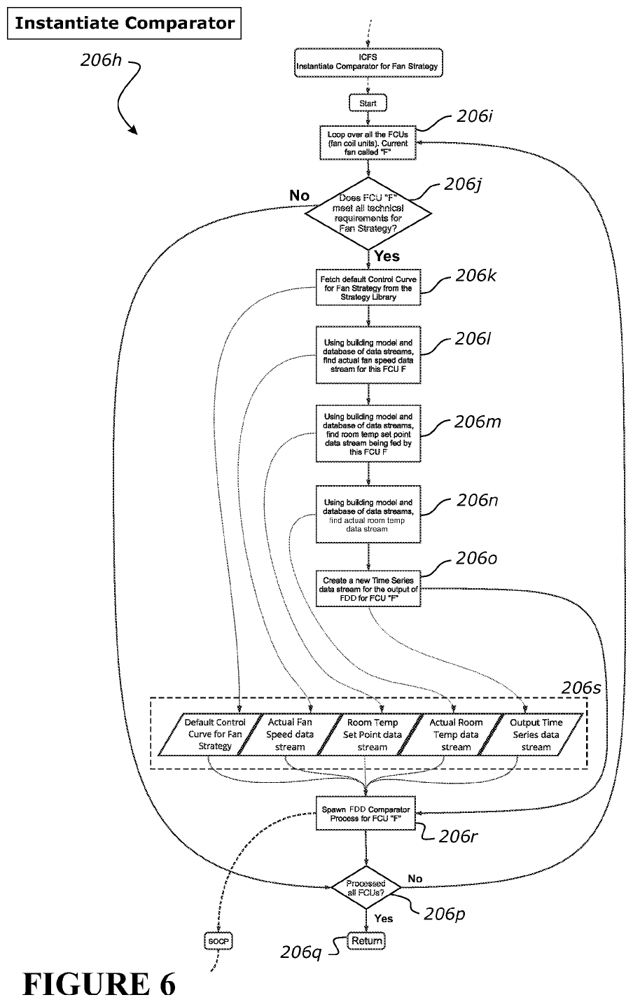

Referring to FIG. 6, the comparator initialisation process 206h starts by looping or cycling through all the fan coil units (FCUs) in the building model data. Firstly, each FCU is assessed to determine if it meets all the technical requirements for the fan strategy 206g as shown at 206j. If the FCU does not meet the technical requirements, the processing skips that FCU and jumps to step 206p which assesses whether all FCUs have been processed. If they have, the process exits or returns to stage 206e of the FDD module initiation process 206 as shown at 206q. If there are remaining FCUs to analyse, the comparator initialisation process 206h reverts to the initial step 206i to select the next FCU for processing. The logic and flow process of FIG. 6 may be substantially the same for all control strategies, although there may be some optional configuration overrides applied in some circumstances.

If an FCU does meet the technical requirements for the fan strategy as determined at step 206j, the comparator process moves to step 206k which comprises fetching or retrieving the control curve data for the fan strategy from the strategy library 118a. In the next step 206l, the comparator initialisation process 206h retrieves or receives or determines actual fan speed data stream for the FCU based on the digital build model and/or databases of data streams (e.g. recent BMS time-series database 130d). At the next step 206m, the comparator initialisation process 206h retrieves or receives or determines the room temperature set point data stream that is being fed by this FCU based on the digital building model and/or databases of data streams (e.g. recent BMS time-series database 130d). At the next step 206n, the actual room temperature data stream is retrieved or received or determined from the digital building model and/or databases of data streams (e.g. recent BMS time-series database 130d). Finally, at step 206o a new diagnosis time-series data stream is created for populating with the output of the FDD comparator process 206r. The new diagnosis time-series data stream is provided in or by the secondary FDD processor 120c.

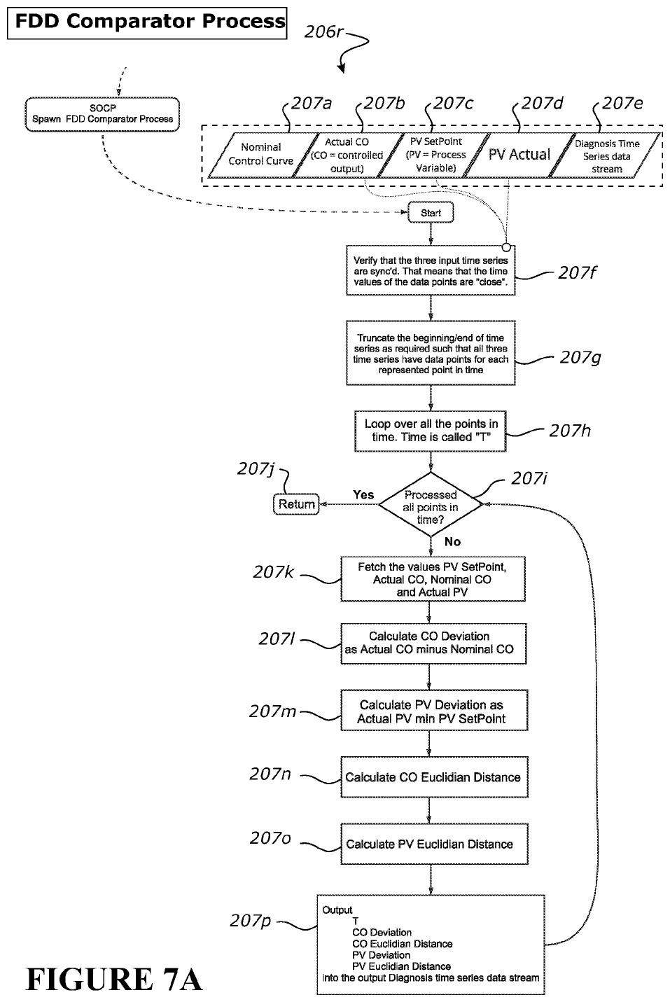

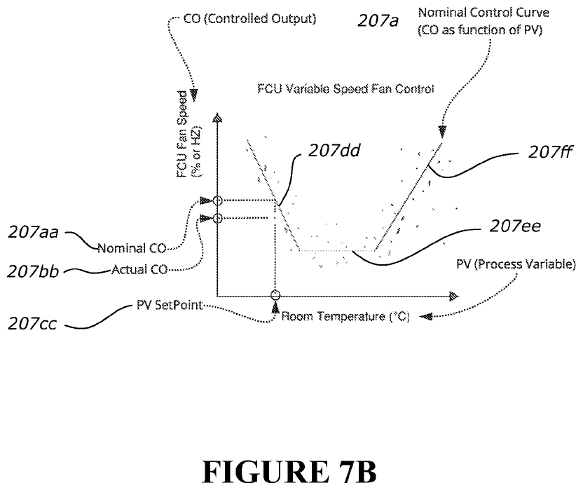

The data and data streams indicated at 206s from stages 206k, 206l, 206m, 206n, and 206o are the passed to the FDD comparator process 206r, which will now be further described with reference to FIGS. 7A and 7B in regard to application of the fan strategy to the specific FCU.

Referring to FIG. 7A, the FDD comparator process 206r receives, retrieves, or references to the various data and data streams as described above at 206s. The input parameters (e.g. data and data streams) include:
Nominal Control Curve (Nominal CO) 207a (e.g. default control curve for fan strategy—see 206k in FIG. 6)
Actual Controlled Output (CO) 207b (e.g. actual fan speed data stream—see 206l in FIG. 6)
Process Variable (PV) Set Point 207c (e.g. room temperature set point data stream—see 206m in FIG. 6)
Process Variable (PV) Actual 207d (e.g. actual room temperature data stream—see 206n in FIG. 6)

The output of the FDD comparator process 206r is a diagnosis time series data stream 207e (e.g. output time series data stream from stage 206o—see FIG. 6). As will be explained in further detail later, in some embodiments, the FDD comparator process 206r can be used for analysing any or the majority of the BMS-controlled building equipment (e.g. components and systems) or a majority of the component-types or categories within the building, with any or a majority of the relevant control strategies from the strategy library 118c. While the various components and control strategies may be different, the same fundamental input data streams and output data streams may be used in the FDD comparator process 206r to determine an optimised control strategy for controlling individual components and systems within the building. In this example configuration, the FDD comparator process 206r does not need to be varied or customised for each different component or control strategy, and this avoids the need for multiple different bespoke or customised FDD comparator processes to be developed for all or at least a majority of the different various building components and possible control strategies that require evaluation.

In this example configuration, the FDD comparator process 206r may commence with some initial pre-processing and/or checking of the incoming data streams, prior to moving to the primary processing stages. However, it will be appreciated that these pre-processing steps may not necessarily be essential in all embodiments or different configurations of the FDD comparator process 206r.

In this example embodiment, the FDD comparator process comprises pre-processing stages 207f and 207g. The FDD comparator process 206r starts at step 207f by verifying that the three input time-series data streams Actual CO 207b, PV Set Point 207c, and PV Actual 207d are synchronised, i.e. verifying that the time values of the data points in the data streams are sufficiently close or aligned (e.g. checking if the time difference between time values is less than a threshold or constant). Following step 207f, the FDD comparator process truncates, if required, a portion or portions of the beginning and/or end of the output diagnosis time-series data stream 207e such that all three input data streams 207b, 207c, and 207d have data points for each represented point in time in the output diagnosis time-series data stream 207e. As will be appreciated, the time interval between data points in the time-series data stream may be at least partly based on the sampling frequency of the incoming data streams.

After the pre-processing stages, the FDD comparator process 206r progresses by looping over all data points in the diagnosis time-series data stream 207e at each discrete time (T) instance in the series as indicated at stage 207h. As shown at 207i, if all data points in the time-series data stream 207e have been processed, the FDD comparator process returns to decision 206p of the comparator initialisation process 206h to see if any further FCU components need processing.

As shown at 207k, for each data point (e.g. time instance/interval) in the time-series data stream 207e, the FDD comparator process 206r fetches or retrieves the following corresponding values from the input data streams 207a-207d respectively for that corresponding time instance: Nominal CO 207a, Actual CO 207b, PV Set Point 207c, and PV Actual 207d.

The algorithm or process 206r then progresses to calculate or determine a value representing or indicative of the controlled output deviation (CO Deviation) or error between the Actual CO and Nominal CO (e.g. CO Deviation=Actual CO−Nominal CO), as shown at 207l. Following this, the algorithm or process 206r calculates or determines a value representing or indicative of the process variable deviation (PV Deviation) or error between the PV Actual and PV Set Point (e.g. PV Deviation=PV Actual−PV Set Point), as shown at 207m.

The algorithm or process 206r then progresses to calculate or determine the Controlled Output Euclidian Distance (e.g. CO Euclidian Distance) as shown at 207n, and the Process Variable Euclidian Distance (e.g. PV Euclidian Distance) as shown at 207o.

By way of further explanation, in one embodiment, the CO Euclidian Distance may be the distance between the data points defined by co-ordinates (Actual CO, PV Actual) and (Nominal CO, PV Set Point). The PV Euclidian Distance may be the distance between the data points defined by co-ordinates (PV Actual, Nominal CO) and (PV Set Point, Actual CO).

The final stage in the FDD comparator algorithm or process 206r is the output stage 207p in which the process 206r outputs, inserts or populates the following data set or data package into the diagnosis time-series data stream 207e (which may be stored in recent FDD time-series database 120e) for that discrete time instance T:
T
CO Deviation
CO Euclidian distance
PV Deviation
PV Euclidian distance

Referring to FIG. 7B, a graphic example of the data streams and data points being used and determined by the FDD comparator process 206r is shown as applied to the FCU component and fan strategy example. The graph of FIG. 7B shows the nominal control curve (e.g. series of line segments in this example) 207a for the CO—Controlled Output (e.g. FCU fan speed in this example) plotted against the PV—Process Variable (e.g. room temperature in this example). In this example, the nominal control curve 207a representing the fan strategy is defined as a series of line segments. For other control strategies, the nominal control curve may be represented or defined by any desired schema, format, function, look-up table or the like. The graph also shows dots representing data values or co-ordinates of the Actual CO vs PV Set Point for various time instances extracted from the incoming data streams 207b and 207c previously discussed.

By way of further explanation, FIG. 7B shows a potential ‘input’ scenario, which is fan speed as a function of the targeted room temperature. In this example, the line segments representing the nominal control curve 207a comprise first line segment 207dd, second line segment 207ee, and third line segment 207ff. In this example, the first line segment 207dd and associated data points represent an associated heating valve being open >3%. The second line segment 207ee represents no valves open >3%, and its associated data points represent both heating and cooling valves open >3%. The third line segment 207ff and associated data points represent an associated cooling valve open >3%. The marked points 207aa, 207bb, and 207cc demonstrate how the FDD comparator process is analysing the inputs. For example, at PV Set Point marked 207cc, the nominal control curve 207a requires that the Controlled Output (CO) be the Nominal CO marked at 207aa. However, the actual behaviour in the building is shown by the Actual CO marked at 207bb. The difference between the Actual CO and Nominal CO is the CO Deviation at this point in time.

Reverting to FIG. 7A, following output stage 207p, the FDD comparator process 206r then reverts to decision stage 207i to determine if any further time instances T in the input data streams need processing. If further, data points and time instances T in the data streams need processing, the process repeats the steps 207k-207p again on the next set of data point values (see 207k) for the next time instance T in the time-series 207e. In this FDD comparator process mode, the amount of data analysed may be configured or controlled, e.g. the process may be configured to analyse a configurable sample of historical data, e.g. a year of historical data, week of historical data, a day of historical data, or any other configurable time window of data desired.

Once the diagnosis time-series data stream 207e has been completed (i.e. all data points in the desired or configurable time window of data have been analysed) by the comparator process 206r for the current component (e.g. FCU in this example) being processed, the process returns 207j to stage 206p of the comparator initialisation process 206h. Reverting to FIG. 6, the comparator initialisation process 206h at stage 206p determines whether any further components related to the fan strategy (FCUs in this example) need to be processed by the FDD comparator process 206r. If so, the data streams for the remaining FCUs are each processed by the FDD comparator process 206r as explained above. Once all FCUs have been processed, the comparator initialisation process 206h has generated a diagnosis time-series data stream 207e for each component (e.g. FCU) for the fan strategy, and the process returns to stage 206e of the FDD module initiation process 206, as shown at 206q. In this embodiment, it will be appreciated that multiple FDD comparator processes 206r may be spawned concurrently on different components. For example, multiple threads of the process 206r may run concurrently and independently of each other. This is also the case for any other algorithms described herein that refer to ‘spawned’ algorithms, processes, or threads. In particular, the algorithms may spawn multiple concurrent processes or threads that are analysing or processing data on different strategies and/or components and/or stages.

Upon returning to stage 206e in FIG. 5, the FDD module initiation process 206 then determines whether any further control strategies 206d from the strategy library 118c need processing by the FDD comparator initialisation process 206h. Each of the remaining control strategies 206d are applied to the FDD comparator initialisation process 206h as shown at 206c. As noted above, an independent FDD comparator initialisation process 206h is spawned for each strategy being processed, and these threads may operate sequentially, concurrently or a combination of these depending on processing resources. Once all control strategies have been processed, the FDD module initiation process 206 returns to the system process 200 of FIG. 3, as shown at 206f.

The output of the FDD module initiation process 206 is output data sets or data streams representing the diagnosis time-series data streams for all the building components associated or related to each of the available control strategies in the strategy library 118c. It will be appreciated that the processes above may continuously operate if there is further incoming data streams for processing and/or until a termination signal is received, for example by a system user. In this embodiment, the diagnosis time-series data streams are stored in the recent FDD time-series database 120e, for example.

### FDD Strategy Recommendation Process

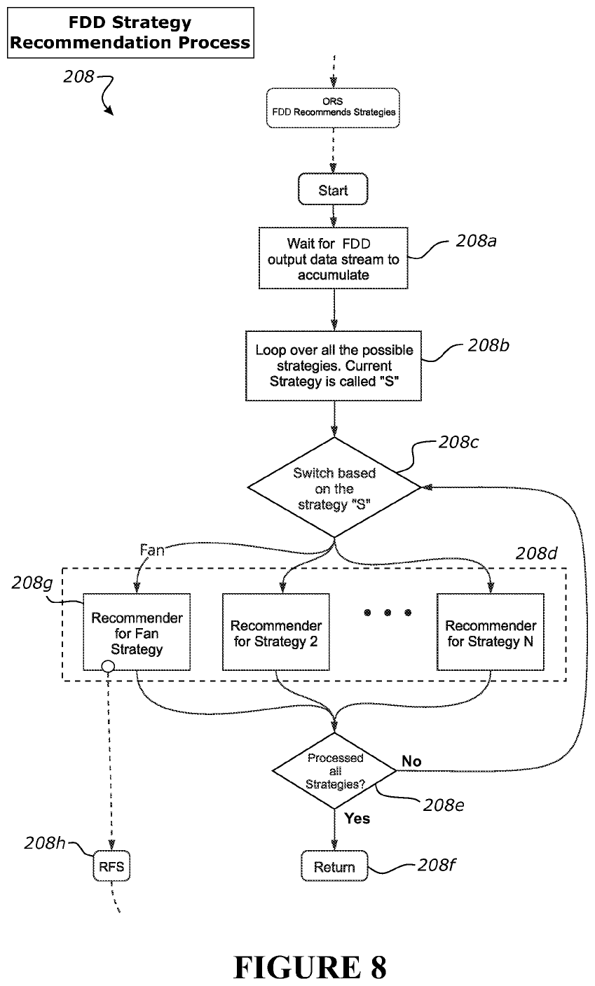

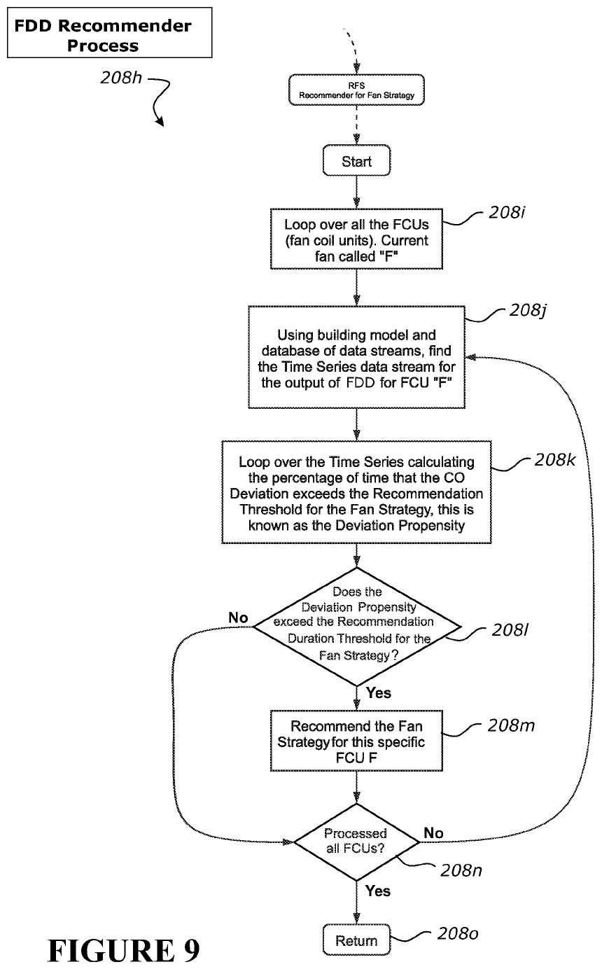

Following the FDD module initiation process 206, the system process 200 moves to the next step or stage comprising the FDD strategy recommendation process 208, which will now be explained in further detail with reference to FIGS. 8 and 9.

In some embodiments and configurations, the FDD strategy recommendation process 208 may initiate or commence once sufficient partial diagnosis time-series data streams 207e has been generated or accumulated from the FDD module initiation process 206. In other configurations, the FDD strategy recommendation process may commence once all diagnosis time-series data streams have been generated.

Referring to FIG. 8, in this example embodiment, the FDD strategy recommendation process 208 starts by waiting for sufficient diagnosis time-series data streams 207e to be generated by the FDD module initiation process 206. Once sufficient data streams for processing are available, the strategy recommendation process 208 progresses to loop over all the possible control strategies in the strategy library 118c as shown at 208b with a recommender process. In one configuration, what qualifies as a sufficient amount of data for the strategy recommendation process 208 to commence may be a function of both the number of data streams (e.g. number of fans or components processed), and the length or duration of those data streams (e.g. length of time for which diagnostic information is available).

The process 208 cycles or loops through and processes each control strategy 208d with a recommender process to generate output recommendation data representing the processed and/or analysed control strategies. The processing cycles or switches through the different control strategies at 208c until all the control strategies are processed as shown at decision 208e. In particular, after processing a control strategy, the process 208 determines at decision 208e whether there are any further control strategies to process. If there are, the process returns to stage 208c to switch to the next control strategy to process. If all the control strategies have been processed, the process returns to the main system flow 200 as shown at 208f.

By way of example, the processing of a first example control strategy will be described and this process is similar for each control strategy. In this example, following on from the description of the FDD module initiation process 206, the first example control strategy to be processed is a ‘fan strategy’ 208g. The processing of the fan strategy 208g spawns or initiates an FDD recommender process as shown at 208h.

Referring to FIG. 9, the FDD recommender process 208h starts by looping or cycling through all the fan coil units (FCUs) in the building model data as shown at 208i. For each FCU, the recommender process undertakes the data retrieval stage 208j. In particular, for the current FCU being processed, the data retrieval stage 208j comprises identifying and extracting and/or retrieving and/or accessing the corresponding or associated diagnosis time-series data stream 207e for the current FCU being processed. In some configurations, the relevant diagnosis time-series data stream may be identified and retrieved and/or accessed based on the building model data and/or database(s) of data streams. In one configuration, the relevant diagnosis time-series data stream for the current FCU is identified and extracted and/or accessed from the FDD time-series database 120c, as output from the FDD module initiation process 206.

Once the relevant or associated diagnosis time-series data stream for the current FCU is identified and retrieved and/or accessed, the FDD recommender process progresses to the analysis stage 208k. In the analysis stage 208k, the FDD recommender process analyses the diagnosis time-series data stream 207e for the FCU to determine or calculate a deviation value representing and/or indicative of the proportion or percentage of time that the Controlled Output Deviation (CO Deviation) exceeds a configurable or preset recommendation threshold value. It will be appreciated that other deviation values or metrics may be used for expressing energy consumed when running in a sub-optimal manner. In one example configuration, the deviation value generated is a deviation propensity value that represents the percentage of time that the CO Deviation value exceeds the recommendation threshold. In this example, the deviation propensity value represents that percentage of time that the CO Deviation value for the diagnosis time-series data stream of the FCU exceeds the recommended threshold associated with the fan strategy.

Following the analysis stage 208k, the FDD recommender process determines whether the deviation propensity value exceeds a recommendation duration threshold for the control strategy, as shown at stage 208l. In this example, the FDD recommender process compares the deviation propensity value for the FCU from the analysis stage 208k to a configurable or preset recommendation duration threshold. If the deviation propensity value exceeds the recommendation duration threshold, the FDD recommender process outputs or stores data (e.g. recommendation data) recommending the control strategy (‘fan strategy’ in this example) for the specific or current FCU being processed as shown at 208m. If the deviation propensity value does not exceed the recommendation duration threshold, the FDD recommender process jumps to stage 208n. In some configurations, the recommendation duration threshold may be different or customised to the control strategy, in other configurations the recommendation duration threshold may be uniform across the different control strategies.

At stage 208n, the FDD recommender process jumps to determine if any further FCUs need to be processed. If there are remaining FCUs to process, the process returns or loops back to repeat steps or stages 208j-208n for each of the next remaining FCUs, until all FCUs have been processed. Once all FCUs have been processed, the FDD recommender process 208h returns to step 208e in the FDD strategy recommendation process 208, as shown at 208o.

In other embodiments, the FDD recommender process may be configured to convert the controlled output (e.g. fan speed) to an energy consumption value representing the energy forecasted to be consumed at the fan speed. The FDD recommender process can then be configured to set a recommendation threshold that relates to energy savings. For example, if the recommendation threshold is set to 10%, we know the control strategy is only recommended if it saves at least 10% of the fan's energy consumption.

The output of the FDD recommender process 208h for each control strategy (e.g. fan strategy in this example) is a set of recommendation data for one or more of the components (e.g. FCUs in this example) that identifies which FCUs would benefit from the control strategy (e.g. fan strategy) being analysed.

Upon returning to stage 208e of the FDD module initiation process 208 in FIG. 8, the FDD strategy recommendation process 208 then determines whether any further control strategies 208d from the strategy library 118c need processing by the FDD recommender process 208h. Each of the remaining control strategies 208d are then applied to the FDD recommender process 208h as shown at 208c. Once all control strategies have been processed, the FDD strategy recommender process 208 returns to the system process 200 of FIG. 3, as shown at 208f.

The output of the FDD strategy recommendation process 208 is output data sets or data streams representing recommendation data for all the building components associated or related to each of the available control strategies in the strategy library 118c. This recommendation data represents or is indicative of which (if any) control strategies are recommended for each building component, based on the recommendation thresholds. In this embodiment, the recommendation data is stored in the strategy store database 118c.

### FDD Augmentation Process

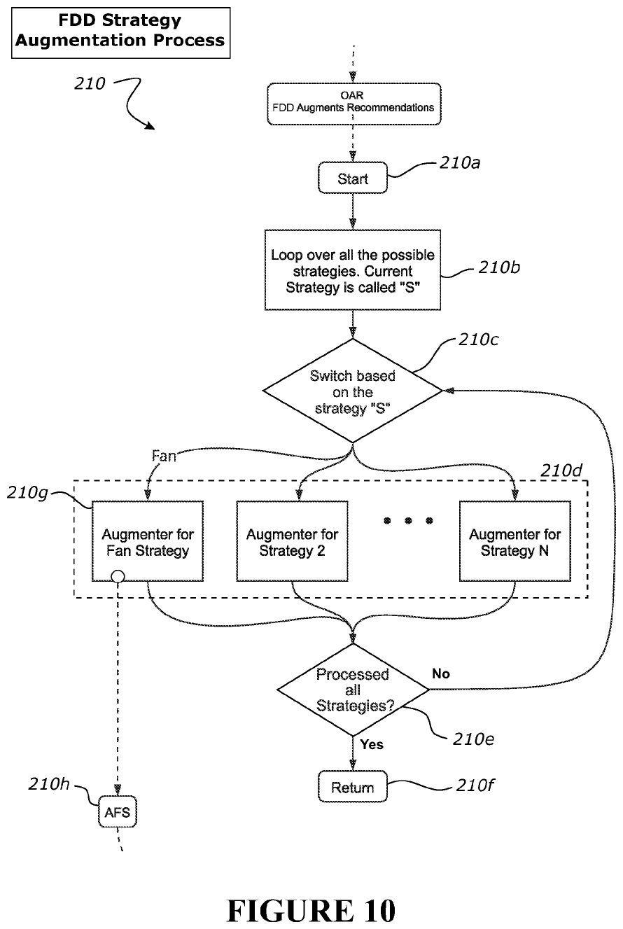

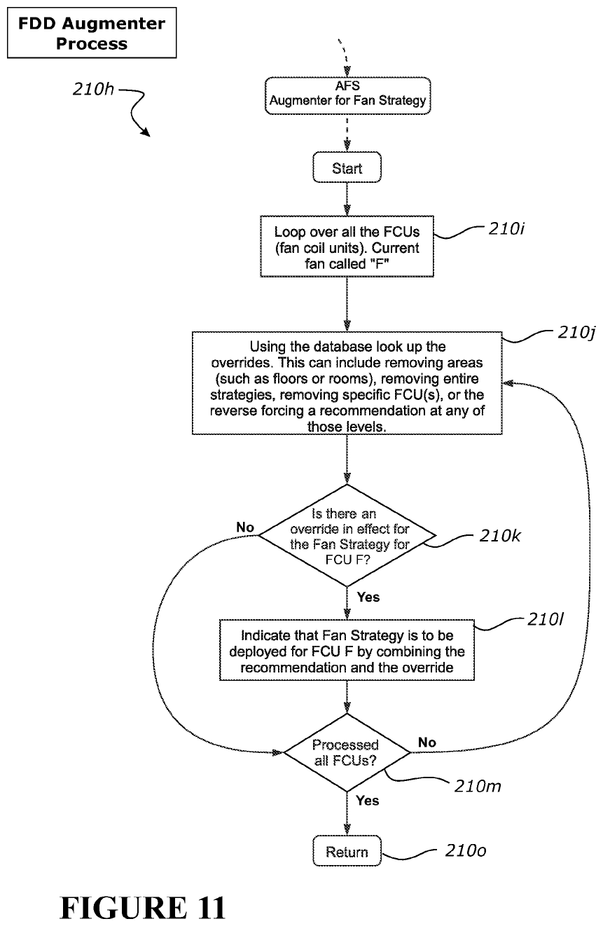

In this example embodiment, following the FDD strategy recommendation process 208, the system process 200 moves to the next step or stage comprising the FDD augmentation process 210, which will now be explained in further detail with reference to FIGS. 10 and 11. This augmentation process 210 may be optional in some configurations or alternative embodiments.

Referring to FIG. 10, in this example embodiment, the FDD augmentation process 210 starts 210a by cycling or looping through all the possible control strategies 210d with an augmenter process as shown at 210b to generate augmentation data to supplement the recommendation data from the FDD strategy recommendation process 208.

The FDD augmentation process 210 cycles or switches through the different control strategies for processing at 210c. In particular, after processing a control strategy, the process 210 determines at decision 210e whether there are any further control strategies to process. If there are, the process returns to stage 210c to switch to the next control strategy to process. If all the control strategies have been processed, the process 210 returns to the main system flow 200 as shown an 210f.

By way of example, the processing of a first example control strategy will be described and this process is similar for each control strategy. In this example, following on from the description of prior processes 206 and 208, the first example control strategy to be processed is a ‘fan strategy’ 210g. The processing of the fan strategy 210g calls or initiates an FDD augmenter process as shown at 210h.

Referring to FIG. 11, the FDD augmenter process 210h starts by looping or cycling through all the fan coil units (FCUs) in the building model data as shown at 210i. For each FCU, the augmenter process undertakes a data retrieval stage 210i. In particular, for the current FCU being processed, the data retrieval stage 210j comprises identifying if any override data exists for the FCU being processed. The override data may include, by way of example only, data or instructions for removing one or more building areas (e.g. floors or rooms), removing entire control strategies, removing specific FCU(s), or reverse forcing a strategy recommendation at any of these levels. In some configurations, the override data may be generated, input, and/or configured by a human or administrator or operator via a user interface of the system and/or may be at least partly or entirely automatically generated by the system. In this example configuration, the override data may be stored in a database (e.g. strategy store database 118c) in the cloud platform 108. In some embodiments, the strategy store database 118c may be stored in the building model database 116e, or may be stored independently.

After identifying and/or retrieving any relevant override data for the current FCU being processed, the FDD augmenter process moves to decision stage 210k. If relevant override data is identified for the FCU at decision stage 210k, the process moves to deployment data update stage 210l.

At deployment data update stage 210l, deployment data for the current FCU is updated to reflect that the control strategy (e.g. ‘fan strategy’ in this example) is to be deployed for the FCU based on the recommendation data from the FDD strategy recommendation process 208 in combination with the override data identified and/or retrieved from the FDD augmentation process 210. If no override data is identified for the FCU at decision stage 210k, then the process moves to stage 210m to determine whether all FCUs have been processed. If there are remaining FCUs to process, the process returns or loops back to repeat steps or stages 210j-210m for each of the next remaining FCUs, until all FCUs have been processed. Once all FCUs have been processed, the FDD augmenter process 210h returns to step 210e in the FDD augmentation process 210, as shown at 210o. The logic and flow process of FIG. 11 may be substantially the same for all control strategies, although there may be some optional configuration overrides applied in some circumstances.

The output of the FDD augmenter process 210h for each control strategy (e.g. ‘fan strategy’ in this example) is a set of deployment data comprising or identifying (e.g. linking or pointing to) the recommendation data and any relevant override data for each component processed (e.g. FCU in this example). In some configurations, the deployment data may be stored in a database in the cloud platform. In some configurations, the deployment data for each component may comprise the recommendation data and any override data relevant to each component. In other configurations, the deployment data may comprise links or pointers to at least some or all of the recommendation data and any override data relevant to each component.

In some embodiments, the output of the FDD augmenter process 210h for each control strategy is data stored in strategy store database 118c that represents information about the deployment of control strategies for buildings, including the current building B. For every equipment instance E in the digital building model for B (in building model database 116e), the data in strategy store database 118c indicates for every strategy S whether S was recommended for equipment instance E (or not), the override for S for E (forcing deployment on or off), and the combination of the two. In embodiments where the strategy store data 118c is within the building model 116e, the recommendation and override data of 118c may be “attributes” or parameters in the digital building model. For example, in one embodiment, the recommendation and override data in strategy store 118c may be within the digital building model 116e as data “attached” to the many different equipment instances E(s) in the digital building model for building B 116e (e.g. could be thousands or tens of thousands or a much large number of equipment components, depending on the building size and complexity).

In some embodiments, the deployment data may comprise the recommendation data and override data, and other data sets. The other data sets may include control curves, parameter sets for driving and configuring control strategies. In some embodiments, the deployment data represents data that indicates to the optimizer 110a in the onsite controller 110 whether a strategy S is on or not for a particular equipment instance E (e.g. fan), and if on, the configuration data for the strategy S in effect for that equipment instance E.

Upon returning to stage 210e of the FDD augmentation process 210 in FIG. 10, the FDD augmentation process 210 then determines whether any further control strategies 210d from the strategy library 118c need processing by the FDD augmenter process 210h. Each of the remaining control strategies 210d are then applied to the FDD augmenter process 210h as shown at 210c. Once all control strategies have been processed, the FDD augmenter process 210 returns to the system process 200 of FIG. 3, as shown at 210f.

The output of the FDD augmentation process 210 is output data sets or data streams representing the deployment data (e.g. recommendation data and any override data) for all the building components associated or related to each of the available control strategies in the strategy library 118c.

### Optimizer Rollout Planner Process for Optimizer Engine Rollout

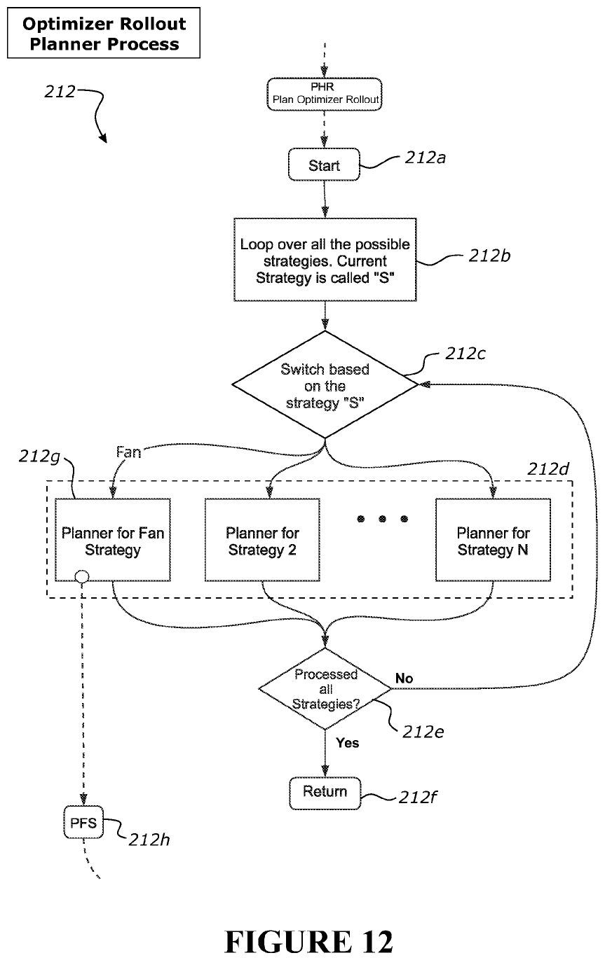

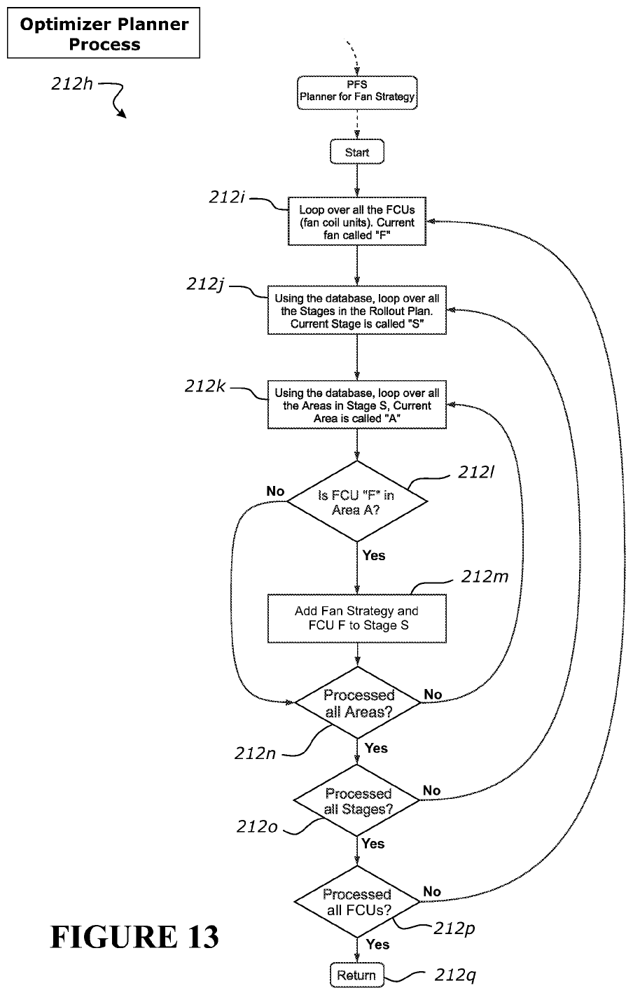

In this example embodiment, following the FDD augmentation process 210, the system process 200 moves to the next step or stage comprising the optimizer rollout planner process 212, which will now be explained in further detail with reference to FIGS. 12 and 13.

Referring to FIG. 12, in this example embodiment, the optimizer rollout planner process 212 executed by the FDD engine 120a starts at 212a by cycling or looping through all the possible control strategies 212d with a planner process as shown at 212b to generate rollout stage data for deploying the determined optimized control strategies to control various components of the building.

The optimizer rollout planner process 212 cycles or switches through the different control strategies for processing at 212c. In particular, after processing a control strategy, the process 212 determines at decision 212e whether there are any further control strategies to process. If there are, the process returns to stage 212c to switch to the next control strategy to process. If all the control strategies have been processed, the process 212 returns to the main system flow 200 as shown at 212f.

By way of example, the processing of a first example control strategy will be described and this process is similar for each control strategy. In this example, following on from the description of the prior processes 206, 208, 210, the first example control strategy to be processed is a ‘fan strategy’ 212g. The processing of the fan strategy 212g calls or initiates a FDD planner process as shown at 212h.

Referring to FIG. 13, the optimizer planner process 212h starts by looping or cycling through all the fan coil units (FCUs) in the building model data as shown at 212i. For each FCU, the planner process loops over all stages in a rollout plan defined by rollout data stored in a database as shown at 212j. In this example embodiment, the rollout plan comprises data indicative of stages (S) and areas (A) of the rollout plan. The data indicative of stages (S) indicates a progression of one or more stages of rollout of the control strategies (via the optimizer), e.g. ranging from an initial rollout stage covering a small number of equipment instances, to later more complete rollout stages covering all intended equipment instances. The areas (A) of the building may be areas such as a floor, a room, a corridor that are linked to one or more equipment instances. In one configuration, the digital building model may comprise data that links certain areas (A) to each of the rollout stages (S).

In one example embodiment, the rollout plan comprises data indicative of or representing a set of Stages, and for each Stage a set of Areas to be included in that Stage. In one example, in this embodiment, the set of stages is fixed but it may be variable. Depending on the configuration, there may be one or more stages, each stage representing a progression in the rollout of the optimized control strategies. For example, in one configuration there are three stages. The first stage is configured to run strategies on a single equipment instance in a corner of the building, for example. The third stage is configured to run the strategies everywhere intended (as defined by the deployment data). The second stage is a rollout at some level between stage one and stage three. Other embodiments might have a different number and configuration for the rollout stages. In this embodiment, the planner process is identifying which subset of the entire rollout is being implemented in stage one, and in stage two, in accordance with the rollout plan.

By way of a further example, the rollout plan may comprise data indicative of a set of Stages, and for each Stage the set of Areas to be included in that Stage. By way of example, stage one might be a single Room (an Area) in the corner of the building 114. Stage two might be a Floor (also an Area) that happens to also cover the Room in Stage One.

For each stage (S) in the rollout plan, the optimizer planner process 212h loops over or cycles through all areas (A) in the rollout plan as indicated at 212k. For each area (A) the optimizer planner process determines whether the FCU being processed is in the current area (A) of stage (S) of the rollout plan as shown at 212l. If the FCU is in the current area (A), then the FCU is added to the current stage (S) of the rollout stage data as indicated at 212m. If the FCU is not in the current area (A), then the planner process moves to decision stage 212n to determine if all areas of the stage have been processed. If further areas (A) remain to process, the algorithm loops back to repeat stages 212k-212n. Once all areas (A) in the current stage (S) have been processed, the FDD planner process 212h moves to decision stage 212o where it determines whether all stages of the rollout plan have been processed. If further stages remain, the process loops back to repeat stages 212j-212o until all stages for the current FCU are processed. Once all stages of the rollout plan have been processed, the FDD planner process 212h moves to decision stage 212p where it determines whether all FCUs have been processed. If further FCUs remain for processing, the process loops back to repeat stages 212i-212p until all FCUs have been processed. Once all FCUs have been processed, the FDD planner process 212h returns to step 212e in the FDD rollout planner process 212, as shown at 212q. The logic and flow process of FIG. 13 may be substantially the same for all control strategies, although there may be some optional configuration overrides applied in some circumstances.

The output of the optimizer planner process 212h for each processed control strategy (e.g. ‘fan strategy’ in this example) is a set of rollout stage data that identifies which building components (e.g. FCUs) are to be included for each stage (S) in the rollout plan for that control strategy.

Upon returning to stage 212e of the FDD rollout planner process 212 in FIG. 12, the FDD rollout planner process 212 then determines whether any further control strategies 212d from the strategy library 118c need processing by the FDD planner process 212h. Each of the remaining control strategies 212d are then applied to the FDD planner process 212h as shown at 212c. Once all control strategies have been processed, the FDD rollout planner 212 returns to the system process 200 of FIG. 3, as shown at 212f.

The output of the FDD rollout planner process 212 is output data sets representing the rollout stage data for all control strategies in the strategy library 118c.

In one example configuration, the digital building model maps or links equipment instances (E) to Areas. Areas can overlap with each other, e.g. Floors and Rooms can both be areas. In one embodiment, the input to the optimizer rollout planner process 212 is a ‘High Level Rollout Plan’, which is a set of defined Stages and the mapping of Areas to each of those Stages. By way of example, a building may comprise Room 782 and this might be the Area for Strategy S in Stage 1, and in Stage 2 Floor 7 might be the Area for Strategy S. Noting Floor 7 contains Room 782. In this embodiment, the output of the optimizer planner process 212h is a “Low Level Rollout Plan”, which comprises data indicative of a collection of {S, E} pairs, e.g. {strategy, equipment instance} pairs attached to each of the Stages.

### Optimizer Rollout and Verify for Optimizer Engine

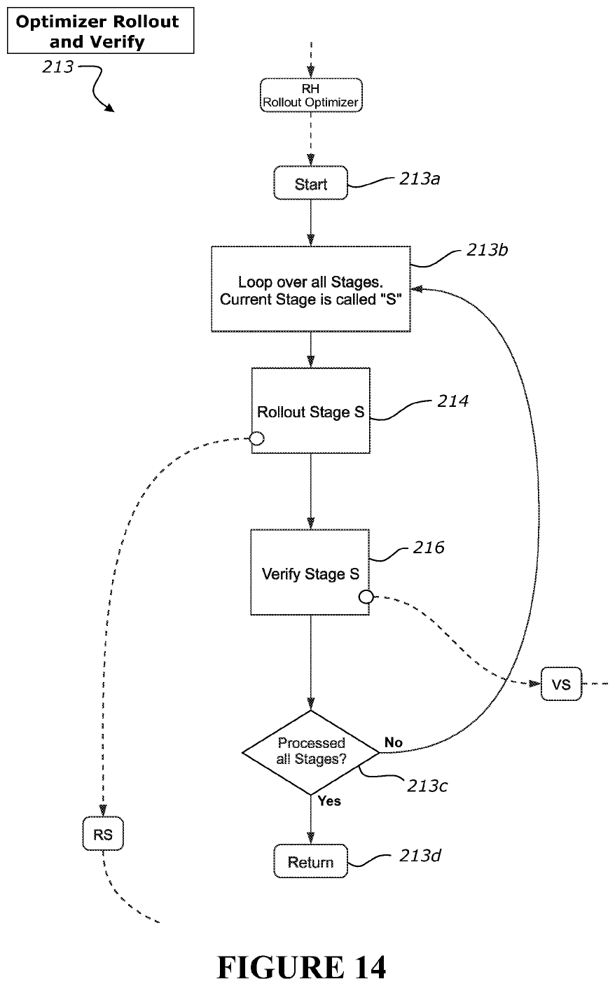

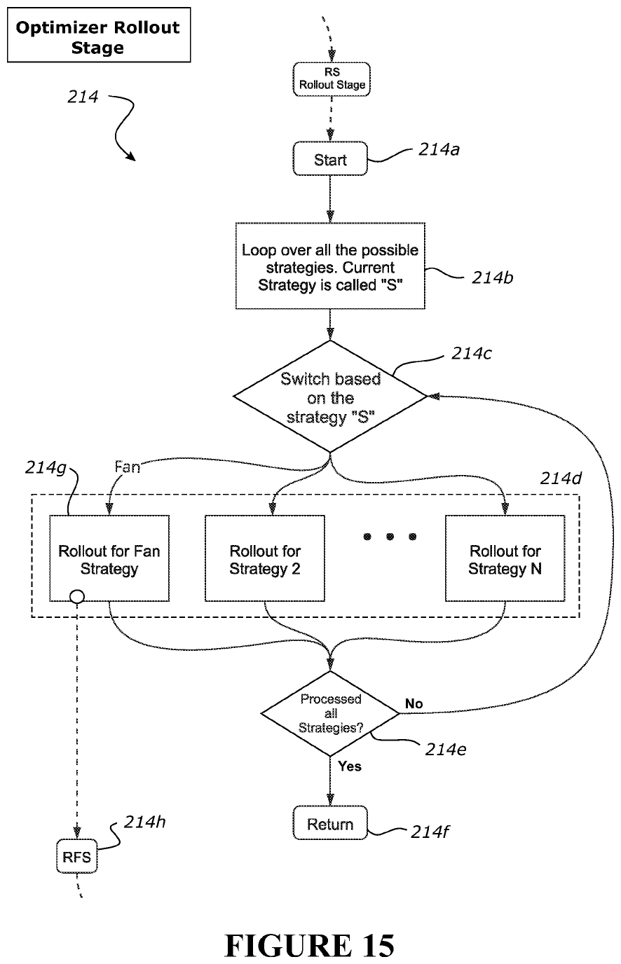

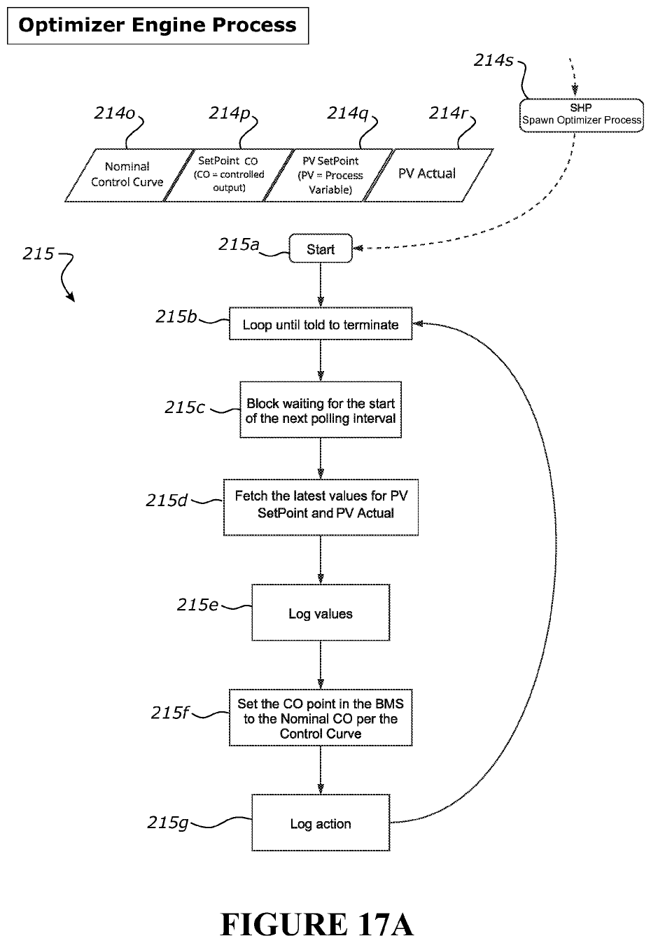

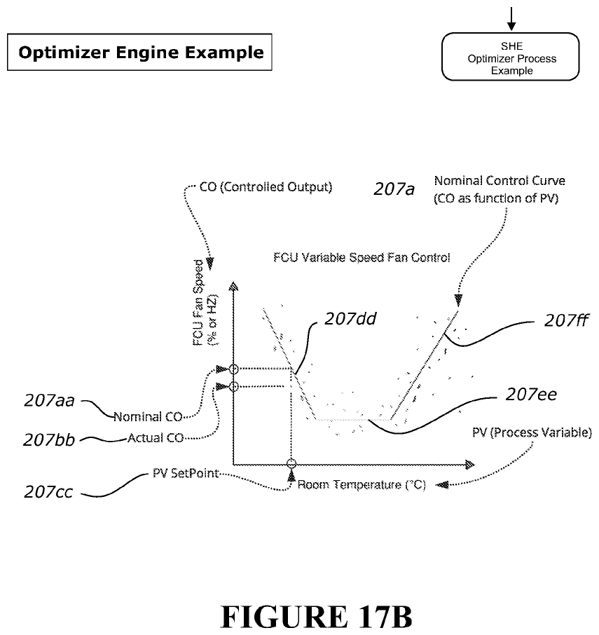

In this example embodiment, following the optimizer rollout planner process 212, the system process 200 moves to the next step or stage comprising the optimizer rollout and verify process 213 for the optimizer engine 110a of the onsite controller 110 installed at the building 114, which will now be described with reference to FIGS. 14-19. Some aspects of the optimizer rollout and verify process 213 are carried out by the FDD engine 120a, and some by the optimizer 110a of the onsite controller 110, as further explained below. For example, the rollout and verify processes of FIGS. 15, 16, 18 and 19 are executed by the FDD engine 120a (e.g. the main FDD processor 120d) in the cloud platform 108, and the optimizer engine process of FIGS. 17A and 17B are executed by the optimizer 110a of the onsite controller 110 on the building side 104 of the system.

Referring to FIG. 14, the optimizer rollout and verify process 213 starts at 213a by cycling or looping through all stages (S) of the rollout plan based on the rollout plan data as shown at 213b. Each stage (S) of the rollout plan is processed by an optimizer rollout stage process 214 and the optimizer verify stage process 216, described further below.

### Optimizer Rollout Stage Process

Referring to FIG. 15, the optimizer rollout stage process 214 applied to each stage (S) of the rollout plan will be described. In this example embodiment, the optimizer rollout stage process 214 starts at 214a by cycling or looping through all the possible control strategies 214d with a rollout strategy implementer as shown at 214b. The rollout strategy implementer configures the optimizer engine 110a of the onsite controller 110 to implement the optimized control strategy for components of the building based on the previously determined system data such as, but not limited to, deployment data, recommendation data, override data and/or rollout stage data. The optimizer engine 110a is configured to override set points (e.g. controlled outputs) of the BMS 112 for specific building components (e.g equipment instances E) in accordance with the optimized control strategies.

The optimizer rollout stage process 214, as applied to each stage of the rollout plan, cycles or switches through the different control strategies for processing at 214c. In particular, after processing a control strategy, the process 214 determines at decision 214e whether there are any further control strategies to process. If there are, the process returns to stage 214c to switch to the next control strategy to process. If all the control strategies have been processed, the process 214 returns to the optimizer rollout and verify process 213 as shown at 214f.

By way of example, the processing of a first example control strategy will be described and this process is similar for each control strategy. In this example, following on from the description of the prior processes 206, 208, 210, and 212, the first example control strategy to be processed is a ‘fan strategy’ 214g. The processing of the fan strategy 214g calls or initiates an optimizer rollout strategy implementer process as shown at 214h.

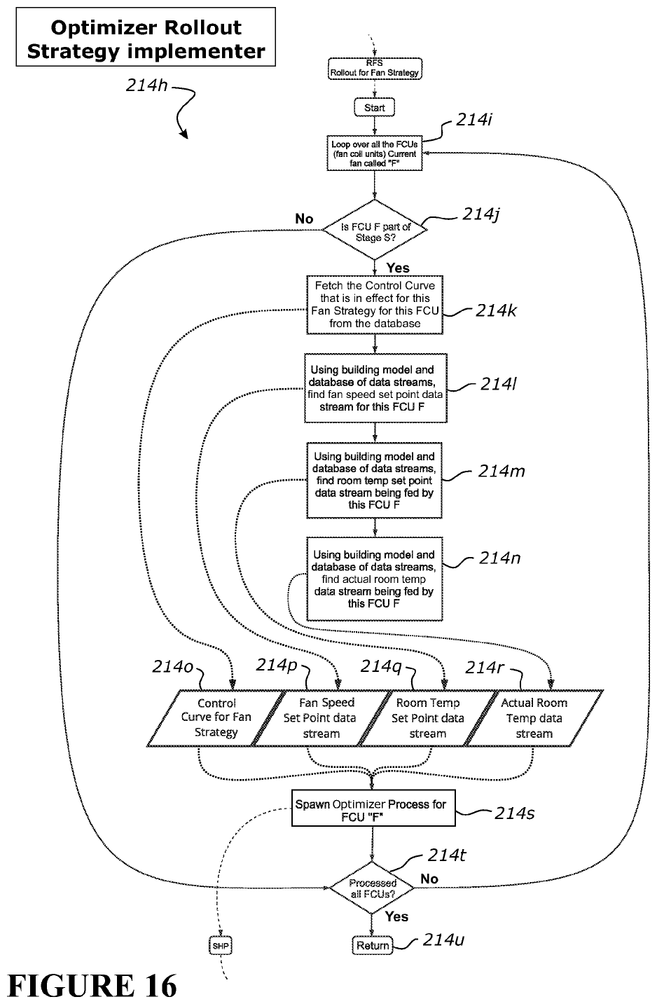

Referring to FIG. 16, the optimizer rollout strategy implementer process 214h starts by looping or cycling through all the fan coil units (FCUs) in the building model data as shown at 214i. For each FCU, the process determines at 214j whether the FCU is part of the current stage (S) 213b being rolled out based at least partly on the rollout stage data generated from the optimizer rollout planner process 212. If the FCU is part of the stage (S), the process moves to the following stages 214k-214s explained further below. If the FCU is not part of the stage (S), then the process takes no further action on that FCU and jumps to decision 214t to determine if any further FCUs need processing. If further FCUs remain for processing, the process loops back to repeat the steps on the next FCU as shown at 214i, until all FCUs have been individually processed. Once all FCUs have been processed, the optimizer rollout strategy implementer process 214h returns to step 214e of the optimizer rollout stage process 214, as shown at 214u. The logic and flow process of FIG. 16 may be substantially the same for all control strategies, although there may be some optional configuration overrides applied in some circumstances.

If an FCU is determined as being part of the current stage (S) being rolled out at assessment 214j, the process proceeds to step 214k. At step 214k, the control curve data for the control strategy (‘fan strategy’ in this example) is retrieved or fetched from the strategy library 118c and provided to data set 214o. In some embodiments, the control curve data may be the default control curve from the strategy library 118a, or the control curve that is in effect based on any applicable overrides and/or modification, e.g. from the strategy store 118c, that are applied to the default control curve. In one configuration, the control curve may comprise one or more equations or functions that define or specify the control strategy behaviour along with any required one or more constraints, variables, parameters, or settings for configuring those equations and/or functions.

Next at step 214l, the fan speed set point data stream for the FCU is accessed or retrieved or identified using the building model data and/or databases, and is provided as data stream 214p. Next at step 214m, the room temperature set point data stream for the FCU is accessed or retrieved or identified using the building model data and/or databases, and is provided as data stream 214q. Next at step 214n, the actual room temperature data stream for the FCU is accessed or retrieved or identified using the building model and/or databases, and provided as data stream 214r.

Once the required data and data streams 214o, 214p, 214q, 214r are accessed or retrieved or identified for the FCU being processed, the FDD rollout strategy implementer process 214h spawns or initiates an optimizer engine process for the FCU, as shown at 214s. The spawning is a parallel process in this configuration, as opposed to a synchronous procedure call.

Referring to FIG. 17, the optimizer engine process 215 for the component (e.g. FCU in this example) will be explained. The optimizer engine process 215 operates in the onsite controller 110. This optimizer engine process 215 is configured to operate in the optimizer engine 110a of the onsite controller 110, and is configured by the cloud platform 108 to override specific behaviours of the BMS 112 based on the optimized control strategy associated or assigned or recommended for the building components, as determined by the previous FDD processes explained.

Each optimizer engine process 215 or thread spawned at 214s executes in the optimizer engine 110a of the onsite controller 110 as noted above. In this example embodiment, each spawned optimizer engine process 215 is a ‘persistent spawn’ with ‘store and forward’ behaviour. Once 214s completes (and moves to 214t) the fact of the spawn is stored in a database in the cloud platform 108. So even if the optimizer engine 110a hasn't received the control signals, configuration data or commands to implement the spawned process, the ‘store and forward’ semantics in the cloud configuration ensures that eventually it does. Further, the ‘persistence’ of each spawned process 215 is also stored in the onsite controller 110. The effect of this is that if the onsite controller 110 crashes or restarts, when it restarts its persistent storage tells it that it needs to re-start the stored optimizer engine processes 215. Further, the optimizer engine process 215 in FIG. 17 is ‘idempotent’ such that it can be crashed at any point and restarted at 215a and still execute correctly. All spawned optimizer engine processes or threads 215 share the ‘persistent spawn’ behaviour.

In this example, the optimizer engine process 215 starts at 215a and loops through steps 215b-215g until instructed or commanded to terminate, as shown at 215b. Termination instructions are received from the cloud platform 108. A termination instruction may be initiated by a system operator for example, to halt all the optimizer engine processes or threads 215, so enable new or modified control strategies to be rolled-out and executed, or for other software updates and/or upgrades. In this example embodiment, the termination would be a ‘persistent termination’ implemented by ‘store and forward’ to match the behaviour of the ‘persistent spawn’.

At step 215c the process waits for the start of the next polling interval. Once the next polling interval starts, the process 215 at step 215d fetches or retrieves the latest data values from the data and data streams 214p and 214q for:
PV Set Point (e.g. room temperature set point), and
PV Actual (e.g. actual room temperature).

In one example configuration, the analysis and control platform 110d and optimizer 110a arrange for all of the ‘read’ points of interest (e.g. room's actual temperature, and fan's set point) to be read every ‘polling interval’ or ‘sampling period’. In one example, that polling interval might be set to 5 minutes (but it will be appreciated any other suitable time period may be selected). During the 5-minute polling interval, the various points of interest (which may be many thousands) are read in a spaced-apart manner or spread over the 5-minute polling interval, rather than all at the same instance in time to avoid crashing the data bus.

The retrieved latest values are then logged back into a database in the cloud platform, such as the optimizer log database 110b. The optimizer engine process 215 then proceeds to set the CO point (e.g. controlled output set point) for the FCU in the BMS 112 via control signals or commands over the BACnet to the Nominal CO value, as derived from the default control curve (e.g. data 214o) for the fan strategy. In one configuration, the optimizer engine process 215 is configured to configure the CO set point according to the Nominal CO value by writing it or a command onto the CO set point data stream 214p. This override of the BMS set point is then logged to the optimizer log database 110b. As previously discussed, this optimizer engine 215 process continues to loop and process the incoming data and data streams, and overrides the BMS CO set points for the FCU, until instructed to terminate. As previously explained, the optimizer engine process 215 may override the BMS set point by writing the optimized set point or generating a command comprising the optimized set point at a higher priority than the BMS command. The command with highest priority takes effect, in accordance with the command priority mechanism of the BMS communication protocol (e.g. BACnet). An optimizer engine example for controlling an FCU in accordance with step 215f is shown graphically in FIG. 17B, which is identical to FIG. 7B explained previously.

At the completion of the optimizer rollout stage 214, each control strategy has been processed with an optimizer rollout strategy implementer 214h for that stage (S) of the rollout. In each optimizer rollout strategy implementer process 214h, each building component (e.g. FCU) relevant to the control strategy is processed to determine whether it is part of the rollout stage (S). If it is, an optimizer engine process 215 is spawned for that building component in the optimizer 110a of the onsite controller 110 so that the BMS 112 control logic or behaviour for that component is overridden in real-time in accordance with the optimized control strategy. As such, the optimizer rollout process can spawn multiple (e.g. thousands or more) optimizer engine processes or threads operating in parallel on different respective individual components of the building for the various control strategies being rolled out.

Once the optimizer rollout stage process 214 is completed for all control strategies 214d for the current stage (S), the process returns to the optimizer rollout and verify process 213 as shown at 214f, and proceeds to the verify stage 216, which will now be explained. FDD verify stage process

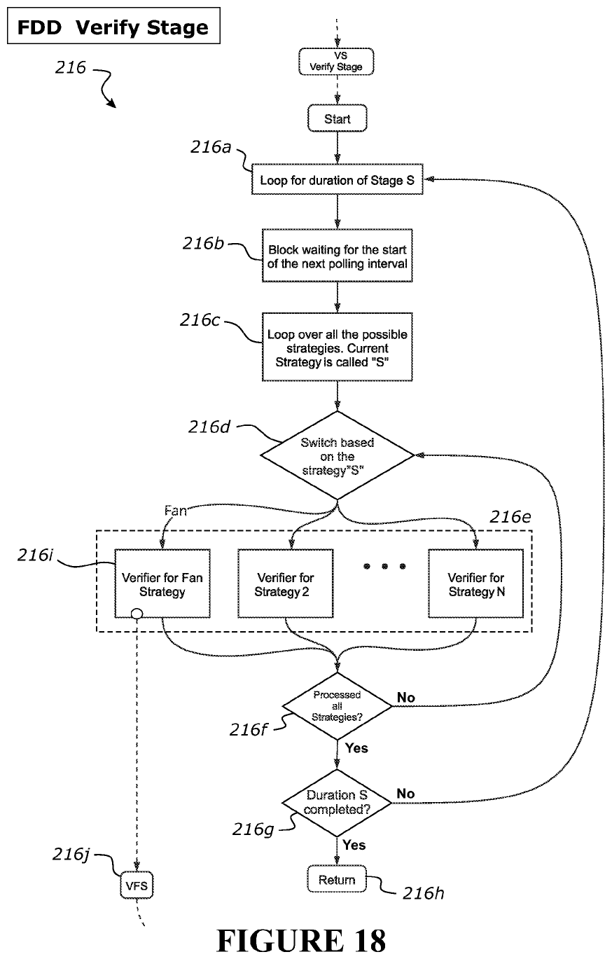

Referring to FIG. 18, the FDD verify stage process 216 initiates once the optimizer rollout stage process 214 for the stage (S) has completed. The FDD verify stage process 216 starts and loops for the duration of stage (S), as indicated at 216a. By way of example, stage 1 of the rollout might run for a first duration (e.g. number of days or weeks), and stage 2 of the rollout for a second duration (e.g. a number of days or weeks), before moving to a final stage 3 of the rollout where all desired components or equipment instances of the building are under control of the optimizer 110a. The process 216 then waits for the start of the next polling interval as indicated at 216b, and this is similar to the ‘polling interval’ process described in relation to 215c. Once the next polling interval starts, the process 216 is configured to cycle or loop through all the possible controls strategies 216e with a FDD verifier as shown at 216c. The FDD verifier process is configured to verify that the rolled-out control strategies for the current stage (S) are overriding the BMS 112 control set points as expected and/or within predefined or configurable thresholds or tolerances, i.e. to verify that the optimizer engine processes are working as expected and/or configured.

The FDD verify stage process 216, as applied to each stage (S) of the rollout plan, cycles or switches through the different control strategies for processing at 216d. In particular, after processing a control strategy, the process 216 determines at decision 216f whether there are any further control strategies to process. If there are, the process 216 returns to stage 216d to switch to the next control strategy to process. If all the control strategies have been processed, the process 216 moves to decision 216g to determine if the duration of stage (S) has completed. If the duration has not completed, the process loops back to repeat stages 216a-216g, until the duration has completed. Once the duration has completed, as determined at stage 216g, the process exits or returns to the FDD rollout and verify process 213, as shown at 216h.

By way of example, the verification processing by the verifier of a first example control strategy will be described and this process is similar for each control strategy. In this example, following on from the description of the prior processes 206, 208, 210, 212, and 214, the first example control strategy to be processed is a ‘fan strategy’ 216i. The processing of the fan strategy 216i spawns or initiates an FDD verifier process as shown at 216j.

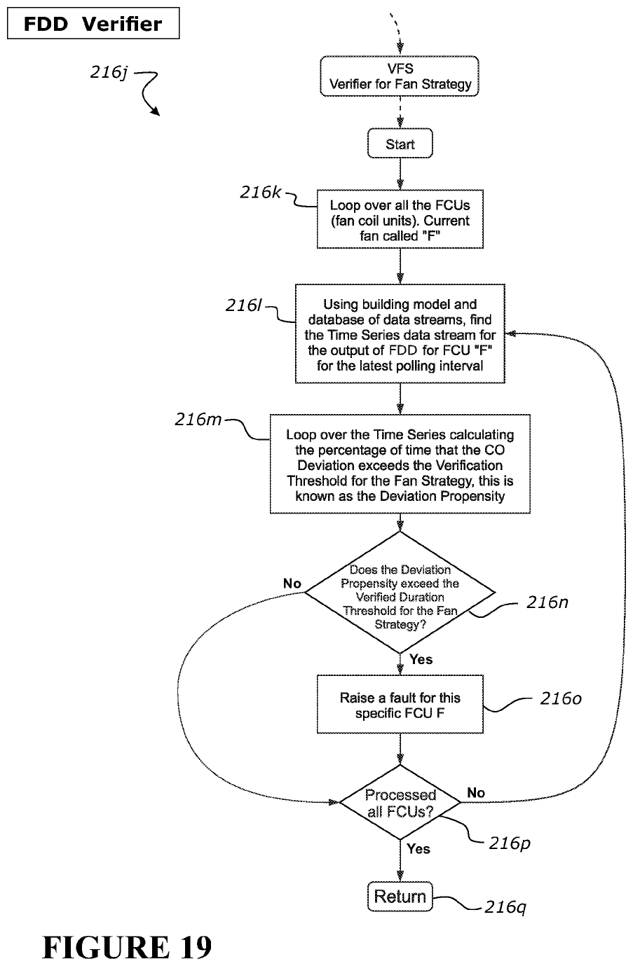

Referring to FIG. 19, the FDD verifier 216j starts by looping or cycling through all the fan coil units (FCUs) in the building model data as shown at 216k. For each FCU, the process accesses or retrieves from the building model data 116e and the database(s) of time-series data streams (e.g. recent FDD time-series database 120c) output from the FDD engine (e.g. secondary FDD processor 120c) for the FCU for the latest polling interval.

At the next step 216m, the FDD verifier 216j analyses or loops over the accessed or retrieved FDD time-series data streams and calculates or determines a deviation value. In this example, the deviation value is a value indicative of a deviation propensity. In one configuration, the FDD verifier 216j at step 216m is configured to determine or calculate the percentage or proportion of time that the CO Deviation exceeds a verification threshold for the fan strategy, and this percentage represents the deviation propensity value. The CO deviation time-series data stream for the FCU is calculated as CO Deviation=Actual CO−Nominal CO. The verification threshold may be preset or a configurable threshold.

Once the deviation propensity value is calculated for the latest polling interval, the FDD verifier 216j determines at step 216n whether the calculated deviation propensity value exceeds a verified duration threshold for the control strategy (e.g. ‘fan strategy’ in this example). Then verified duration threshold may be preset or a configurable threshold. If the deviation propensity value exceeds the verified duration threshold, the FDD verifier 216j raises or triggers a fault, alarm, or notification indicating a fault in the rollout and/or operation of the optimized control strategy for that specific FCU being processed by the FDD verifier, as shown at 216o. In response to the fault notification, the FCU may be reviewed for faulty operation and/or the optimizer process for that FCU may be re-configured to address the fault and/or improve operation of the FCU to operate in accordance with the optimized fan strategy and/or the fault notification may initiate a root-cause analysis process to identify the root cause of the fault, which might not be the FCU but another HVAC component upstream of the FCU for example. If the deviation propensity value is below the verified duration threshold, the FCU is verified as operating correctly in accordance with the optimised fan strategy and no fault is raised.

After completing the verification of the current FCU, the FDD verifier 216j moves to decision 216p to determine if any further FCUs require processing by the FDD verifier. If further FCUs require processing, the verifier loops back to repeat steps 216l-216p. Once all FCUs have been processed, the FDD verifier 216j exits and returns to step 216f of the FDD verify stage process 216, as shown at 216q.

Upon returning to stage 216f of the FDD verify stage process 216 in FIG. 18, the process 216 then determines whether any further control strategies 216e from the strategy library 118c need processing by the FDD verifier 216j. Each of the remaining control strategies 216e are then applied to the FDD verifier 216j as shown at 216d. Once all control strategies have been processed, the FDD verify stage process 216 moves to decision 216g to determine if the process has looped for the duration of stage (S). If the duration has not completed, the process 216 loops back to repeat steps 216a-216g until the duration is complete. Once the duration of the stage (S) is complete, the FDD verify stage process completes the verification of the current stage (S), and exits and returns at 216h to decision step 213c of the FDD rollout and verify process 213.

Reverting to FIG. 14, upon returning to decision 213c of the FDD rollout and verify process 213 after completion of the verification of the current stage (S), the process determines whether any further stages(S) of the rollout plan need to be rolled out and verified by processes 214 and 216. If further stages of the rollout plan require rollout and verification, the process loops back and repeats steps 213b, 214, 216, and 213c for the remaining stages. Once all the stages have been processed (rolled out and verified) as determined at step 213c, the FDD rollout and verify process 213 returns to the system process 200 of FIG. 3, as shown at 213d.

### FDD Monitoring Process

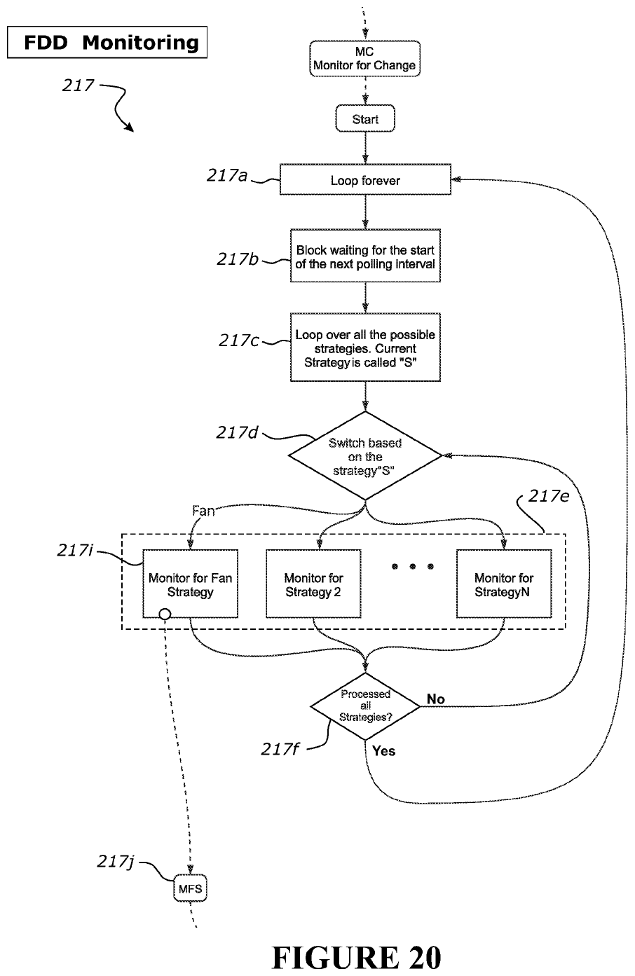

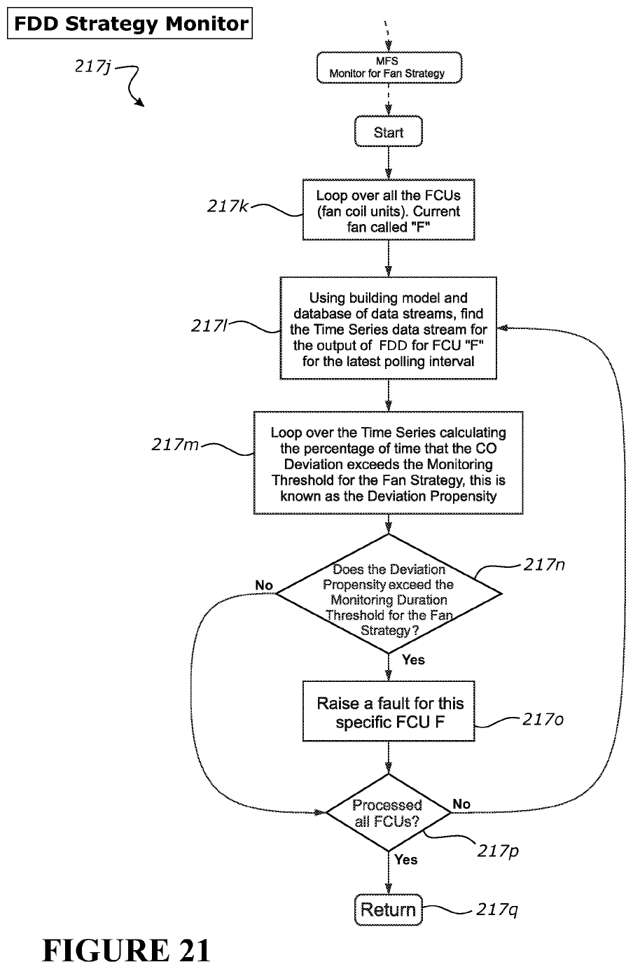

Following the FDD rollout and verify process 213, the system process moves to the next step or stage comprising the FDD monitoring process 217, which will now be explained in further detail with reference to FIGS. 20 and 21.

In this example embodiment, the FDD monitoring process 217 is configured to continuously loop as shown at 217a, such that it continuously monitors the operation of the optimizer engine 110a in real-time. However, it will be appreciated that in alternative embodiments or configurations, the FDD monitoring process 217 may be configured to periodically monitor at a configurable frequency and/or in an ad hoc manner based on a command instruction, e.g. input from a system administrator.

The FDD monitoring process 217 starts by waiting for the start of the next polling interval. Once the next polling interval starts, the FDD monitoring process 217 is configured to cycle or loop through all the different control strategies for monitoring as shown at 217c. In particular, after processing each control strategy with an FDD strategy monitor, the process 217 determines at decision 217f whether there are any further control strategies to process. If there are, the process 217 returns to stage 217d to switch to the next control strategy to monitor. If all control strategies have been monitored for the latest polling interval, the process 217 returns or loops back to the start of the FDD monitoring process at 217a and repeats stages 217a-217f.

By way of example, the monitoring process for each control strategy by the strategy monitor process will be described for a first example control strategy, and the process is similar for each of the other control strategies. In this example, following on from the description of the prior processes, the first example control strategy to be processed is a ‘fan strategy’ 217i. The monitoring of the fan strategy 217i spawns or initiates an FDD strategy monitor as shown at 217j.

Referring to FIG. 21, the FDD strategy monitor 217j starts by looping or cycling through all fan coil units (FCUs) in the building model data as shown at 217k. For each FCU, the strategy monitor accesses or retrieves from the building model data 116e and the database(s) of time-series data streams (e.g. recent FDD time-series database 120c) output from the FDD engine (e.g. secondary FDD processor 120c) for the FCU for the latest polling interval.

In this example configuration, the earlier FDD comparator process 206r of FIG. 7A continuously operates and generates the diagnosis time-series data streams stored in the recent FDD time-series database 120e. The FDD verifier 216j and FDD strategy monitor 217j processes or threads read or access these core diagnosis time-series data streams generated in the cloud platform by the FDD engine, and check for the deviation relative to configurable thresholds (which may differ between the verify and monitor processes), to flag or generate alters to any faults. As discussed earlier, in some configurations, the verify process may be configured with a higher sensitivity or threshold to deviation, such that it raises more alerts or faults, relative to the monitor process.

At the next step 217m, the FDD strategy monitor 217j analyses or loops over the accessed or retrieved FDD time-series data streams and calculates or determines a deviation value. In this example, the deviation value is a value indicative of a deviation propensity. In one configuration, the FDD strategy monitor 217j at step 217m is configured to determine or calculate the percentage or proportion of time that the CO Deviation exceeds a monitoring threshold for the fan strategy, and this percentage represents the deviation propensity value. The CO deviation time-series data stream for the FCU is calculated as CO Deviation=Actual CO−Nominal CO. The monitoring threshold may be preset or a configurable threshold.

Once the deviation propensity value is calculated for the latest polling interval, the FDD strategy monitor 217j determines at steps 217n whether the calculated deviation propensity value exceeds a monitoring duration threshold for the control strategy (e.g. ‘fan strategy’ in this example). Then monitoring duration threshold may be preset or a configurable threshold. If the deviation propensity value exceeds the monitoring duration threshold, the FDD strategy monitor 217j raises or triggers a fault, alarm, or notification indicating a fault in the rollout and/or operation of the optimized control strategy for that specific FCU being processed by the FDD strategy monitor, as shown at 217o. In response to the fault notification, the FCU may be reviewed for faulty operation and/or the optimizer process for that FCU may be re-configured to address the fault and/or improve operation of the FCU to operate in accordance with the optimized fan strategy and/or the fault notification may initiate a root-cause analysis process to identify the root cause of the fault, which might not be the FCU but another HVAC component upstream of the FCU for example. If the deviation propensity value is below the monitoring duration threshold, the FCU is deemed to be operating correctly in accordance with the optimised fan strategy and no fault is raised.

After completing the monitoring of the current FCU, the FDD strategy monitor 217j moves to decision 217p to determine if any further FCUs require processing by the FDD strategy monitor. If further FCUs require processing, the monitor loops back to repeat steps 217l-217p. Once all FCUs have been processed, the FDD verifier 217j exits and returns to step 217f of the FDD monitoring process 217, as shown at 217q. The logic and flow process of FIG. 21 may be substantially the same for all control strategies, although there may be some optional configuration overrides applied in some circumstances.

Upon returning to stage 217f of the FDD monitoring process 217 in FIG. 20, the process 217 then determines whether any further control strategies 217e from the strategy library 118c need processing by the FDD strategy monitor 217j. Each of the remaining control strategies 217e are then applied to the FDD strategy monitor 217j as shown at 217d. Once all control strategies have been processed, the FDD monitoring process 217 returns or loops back to the start of the FDD monitoring process at 217a and repeats stages 217a-217f. In this example embodiment, the FDD monitoring process 217 continues to operate and monitors the BMS optimisation system until manually terminated by a system operator.

### 3. Fault Detection and Diagnostic (FDD) System

In this embodiment, the FDD engine 120 is configured to operate in one or more modes or to carry out one or more functions, as previously described. In one configuration, the FDD engine 120 operates in multiple modes or carried out multiple functions. The first mode is a recommendation mode or as a recommendation engine. The second mode is a verify mode or as a verification engine. The third mode is a monitor mode or as a monitoring engine.

As described, the FDD engine comprises a comparator engine or function that compares incoming BMS time-series data streams of the operation of the equipment instances (e.g. fans, boilers etc) and compares that against nominal control strategy curves to generate a representative diagnosis time-series data stream that is indicative of the performance of the equipment instances in the building (e.g. fans, boilers etc) relative to the one or more control strategies. These diagnosis time-series data streams are generated for the pre-existing BMS operation (i.e. before the optimizer engine 110a and/or control strategies are rolled out to override control aspects of the BMS) so that the FDD can carry out its recommendation mode or function, and also after the optimizer engine 110a is deployed to override the BMS 112a so that the FDD engine can carry out its verify mode and its monitoring mode. In this example, the generated diagnosis time-series data streams are used or analysed in all three of the recommendation, verify, and monitoring modes of the FDD engine 120.

The recommendation function or mode of the FDD engine is then able to analyse that diagnosis time-series data to recommend for each equipment instance which control strategy, if any, to recommend for that equipment instance, based on a configurable recommendation threshold or parameter. The recommendations are then rolled out to the optimizer to override (e.g. using higher priority commands as previously explained) the BMS set points based on the override control strategies, to improve operation of the equipment instances.

Once the rollout of the control strategies is complete, the FDD engine is operable in the verify mode to check the building equipment instances are operating in accordance with the override control strategy as expected. As previously described, in this verify mode or verify function, the FDD engine 120 analyses the incoming diagnosis time-series data to check that the equipment instances are operating in accordance with the recommended override control strategies, and generates alerts, faults or notifications if operation is not to the required level or expectation based on a verification threshold or parameter.

Once the verification mode is completed, and the optimizer engine 110a is operating, the FDD engine is operable in the monitor mode to check the building equipment instances are continuing to operate in accordance with the override control strategies as expected. As previously described, in this monitor mode or monitoring function, the FDD engine 120 analyses the incoming diagnosis time-series data to check that the equipment instances are operating in accordance with the recommended override control strategies, and generates alerts, faults or notifications if operation is not to the required level or expectation based on a monitoring threshold or parameter.

In this embodiment, the various thresholds (i.e. recommendation, verification, monitoring) for the different functions are configurable or tuned based on the specific modes or functions. The recommendation threshold may be configured or set based on one or more desired optimization goals or objectives (e.g. specific energy saving targets). The verification threshold may be set to require high initial compliance of the operation of the building equipment instances with the override control strategies during the rollout phase, so that faults or sub-optimal operation or rollout issues can be identified and fixed early. The monitoring threshold may be set to require a lower compliance of the operation of the building equipment instances with the override control strategies compared to the verification threshold. For example, the monitoring threshold may have a lower sensitivity to error compared to the verification threshold, so that a lower number of fault or error notification alerts are generated during the longer-term operation of the BMS optimization system. For example, during the rollout and verification phase, the verification threshold is set to require more perfection in operation in the system, so that more issues or faults in the roll-out are identified and addressed. During the monitoring phase over the longer term, the monitoring threshold is set to allow for a less perfect system operation and so that only the more major faults or errors in operation trigger alerts.

A benefit of the FDD engine is that it is multi-functional in the recommendation, verify, and monitoring modes, based on analysing similar data streams for a large number of equipment instances, and for different categories or types of equipment instances, and with thresholds in each mode being set or configured based on the function or mode being implemented. This means that the same FDD engine and approach can be used across the bulk of the building equipment instances for the recommendation, verify, and monitoring modes, without requiring individual bespoke FDD routines or algorithms specific to each equipment instance or type of equipment instance.

### 4. Advantages and Benefits of System

The following advantages and/or benefits may apply to at least some configurations or embodiments of the system.

A benefit and/or advantage of an embodiment of the BMS optimisation system is that is operable to be rolled-out or retrofitted to operate with an existing BMS of a building without needing to re-write or update or over-write existing fundamental software or control logic of the BMS. The BMS optimisation system is configured to override set points or targets of the equipment instances being controlled by the BMS, to thereby implement optimized control strategies recommended from the strategy library. The BMS optimisation system is configured to override certain desired set points within the existing BMS control logic in real-time, and therefore does not require an overhaul or update or upgrade to the existing BMS software or control logic. Another benefit and/or advantage of this configuration of the BMS optimisation system is that the pre-existing BMS can revert to its original control logic or behaviour for the building if the optimizer engine and/or onsite controller crashes, faults, disconnects, is turned off or otherwise goes offline for any reason.

As explained above, in some example embodiments, the pre-existing BMS may be agnostic or unaware of the onsite controller and/or optimizer engine such that the pre-existing BMS may continue to operate with or without effect in some areas (depending on which native commands and/or control aspects are overridden by the onsite controller and/or optimizer engine). For example, the onsite controller and/or optimizer engine may exert optimized control over some, all, or certain aspects of building behaviour, and may leave the pre-existing BMS to continue to control the remaining aspects of the building behaviour. As such, the onsite controller and/or optimizer engine can exert targeted control to override one or more aspects of the native control logic of the pre-existing BMS without affecting operation of other aspects. In one example configuration, this is achieved via the onsite controller and/or optimizer engine using higher priority commands to override the native commands of the BMS. This command prioritisation mechanism allows the pre-existing BMS to resume full control of the building behaviour if the onsite controller and/or optimizer engine goes offline, shuts down or faults, as the higher priority commands from the onsite controller and/or optimizer engine halt, thereby allowing the native commands of the BMS to take effect and resume control.

### 5. Terminology and Definitions

The phrases ‘computer-readable medium’ or ‘machine-readable medium’ as used in this specification and claims should be taken to include, unless the context suggests otherwise, a single medium or multiple media. Examples of multiple media include a centralised or distributed database and/or associated caches. These multiple media store the one or more sets of computer executable instructions. The phrases ‘computer-readable medium’ or ‘machine-readable medium’ should also be taken to include any medium that is capable of storing, encoding or carrying a set of instructions for execution by a processor of a computing device and that cause the processor to perform any one or more of the methods described herein. The computer-readable medium is also capable of storing, encoding or carrying data structures used by or associated with these sets of instructions. The phrases ‘computer-readable medium’ and ‘machine readable medium’ include, but are not limited to, portable to fixed storage devices, solid-state memories, optical media or optical storage devices, magnetic media, and/or various other mediums capable of storing, containing or carrying instruction(s) and/or data. The ‘computer-readable medium’ or ‘machine-readable medium’ may be non-transitory.

The term ‘comprising’ as used in this specification and claims means ‘consisting at least in part of’ or ‘including, but not limited to’ such that it is to be construed in an inclusive sense as opposed to an exclusive or exhaustive sense. When interpreting each statement in this specification and claims that includes the term “comprising”, features other than that or those prefaced by the term may also be present. Related terms such as “comprise” and “comprises” are to be interpreted in the same manner.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

The term ‘and/or’ means ‘and’ or ‘or’, or both.

The use of ‘(s)’ following a noun means the plural and/or singular forms of the noun.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount.

### 6. General

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

In the above description, specific details are given to provide a thorough understanding of the embodiments. However, it will be understood by one of ordinary skill in the art that the embodiments may be practiced without these specific details. For example, software modules, functions, circuits, etc., may be shown in block diagrams in order not to obscure the embodiments in unnecessary detail. In other instances, well-known modules, structures and techniques may not be shown in detail in order not to obscure the embodiments.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be rearranged. A process is terminated when its operations are completed. A process may correspond to a method, a function, a procedure, a subroutine, a subprogram, etc., in a computer program. When a process corresponds to a function, its termination corresponds to a return of the function to the calling function or a main function.

Aspects of the systems and methods described above may be operable on any type of general purpose computer system or computing device, including, but not limited to, a desktop, laptop, notebook, tablet, smart television, gaming console, or mobile device. The term “mobile device” includes, but is not limited to, a wireless device, a mobile phone, a smart phone, a mobile communication device, a user communication device, personal digital assistant, mobile hand-held computer, a laptop computer, wearable electronic devices such as smart watches and head-mounted devices, an electronic book reader and reading devices capable of reading electronic contents and/or other types of mobile devices typically carried by individuals and/or having some form of communication capabilities (e.g., wireless, infrared, short-range radio, cellular etc.).

Aspects of the systems and methods described above may be operable or implemented on any type of specific-purpose or special computer, or any machine or computer or server or electronic device with a microprocessor, processor, microcontroller, programmable controller, or the like, or a cloud-based platform or other network of processors and/or servers, whether local or remote, or any combination of such devices.

Furthermore, embodiments may be implemented by hardware, software, firmware, middleware, microcode, or any combination thereof. When implemented in software, firmware, middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

In the above description, a storage medium may represent one or more devices for storing data, including read-only memory (ROM), random access memory (RAM), magnetic disk storage mediums, optical storage mediums, flash memory devices and/or other machine or computer readable mediums for storing information.

The various illustrative logical blocks, modules, circuits, elements, and/or components described in connection with the examples disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general-purpose processor may be a microprocessor, but in the alternative, the processor may be any conventional processor, controller, microcontroller, circuit, and/or state machine. A processor may also be implemented as a combination of computing components, e.g., a combination of a DSP and a microprocessor, a number of microprocessors, one or more microprocessors in conjunction with a DSP core, or any other such configuration.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

One or more of the components and functions illustrated the figures may be rearranged and/or combined into a single component or embodied in several components without departing from the scope of the disclosure. Additional elements or components may also be added without departing from the scope of the disclosure. Additionally, the features described herein may be implemented in software, hardware, as a business method, and/or combination thereof.

In its various aspects, embodiments of the disclosure can be embodied in a computer-implemented process, a machine (such as an electronic device, or a general-purpose computer or other device that provides a platform on which computer programs can be executed), processes performed by these machines, or an article of manufacture. Such articles can include a computer program product or digital information product in which a computer readable storage medium containing computer program instructions or computer readable data stored thereon, and processes and machines that create and use these articles of manufacture.

Although this disclosure has been described in the context of certain embodiments and examples, it will be understood by those skilled in the art that the disclosure extends beyond the specifically disclosed embodiments to other alternative embodiments and/or uses and obvious modifications and equivalents thereof. In addition, while several variations of the embodiments of the disclosure have been shown and described in detail, other modifications, which are within the scope of this disclosure, will be readily apparent to those of skill in the art. It is also contemplated that various combinations or sub-combinations of the specific features and aspects of the embodiments may be made and still fall within the scope of the disclosure. For example, features described above in connection with one embodiment can be used with a different embodiment described herein and the combination still fall within the scope of the disclosure. It should be understood that various features and aspects of the disclosed embodiments can be combined with, or substituted for, one another in order to form varying modes of the embodiments of the disclosure. Thus, it is intended that the scope of the disclosure herein should not be limited by the particular embodiments described above. Accordingly, unless otherwise stated, or unless clearly incompatible, each embodiment of this disclosure may comprise, additional to its essential features described herein, one or more features as described herein from each other embodiment of the invention disclosed herein.

This disclosure may also be said broadly to consist in the parts, elements and features referred to or indicated in this disclosure, individually or collectively, and any or all combinations of any two or more said parts, elements or features, and where specific integers are mentioned herein which have known equivalents in the art to which this disclosure relates, such known equivalents are deemed to be incorporated herein as if individually set forth.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

The scope of the present disclosure is not intended to be limited by the specific disclosures of embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

1. A building management system (BMS) optimization system for optimizing a pre-existing BMS of a building to reduce energy consumption by equipment instances in the building, the pre-existing BMS executing native control logic to control a behavior of the equipment instances in the building via BMS-generated set point commands, the system comprising:
a cloud platform that is configured to:
generate, receive and/or retrieve a digital building model of the building that at least identifies the equipment instances in the building; and
analyze existing behavior of the equipment instances in the building and recommend one or more optimized control strategies from a strategy library to improve one or more aspects of an operation of specific equipment instances in the building;
an onsite controller that is in data communication with the pre-existing BMS of the building, and which is configured to implement the recommended optimized control strategies from the cloud platform by overriding set points of the native control logic of the pre-existing BMS in real-time by generating higher-priority set point commands than the BMS-generated set point commands to thereby optimize the operation of the specific equipment instances in the building; and
a data network or data communication link between cloud platform and onsite controller.

2. The BMS optimization system according to claim 1 wherein the cloud platform comprises a model builder that is configured or operable to generate, receive and/or retrieve the digital building model of the building, the digital building model being generated based on extracting meta data and set points from the BMS relating to the equipment instances of the building.

3. The BMS optimization system according to claim 1 wherein the cloud platform comprises a fault detection and diagnostic (FDD) engine that is configured to process the digital building model, incoming BMS time-series data streams representing operation of the equipment instances of the building, and control strategies from the strategy library to generate recommendation data identifying recommended optimized control strategies for the specific equipment instances and/or specific categories of equipment instances.

4. The BMS optimization system according to claim 3 wherein the FDD engine comprises a comparator that is configured or operable to compare nominal control strategy curves or functions to the incoming BMS time-series data streams to generate one or more deviation parameters representing or indicative of a current operation of the equipment instances in the building relative to the nominal control strategy curves or functions, and which generates diagnosis time-series data streams comprising at least the deviation parameters generated by the comparison.

5. The BMS optimization system according to claim 4 wherein the comparator of the FDD engine receives or retrieves incoming BMS time-series data provided by the BMS that represents, for each equipment instance being analyzed, an actual controlled output set point value for the equipment instance, a process variable set point value associated with the equipment instance, and an actual process variable value associated with the equipment instance, and wherein the diagnosis time-series data streams comprise one or more deviation parameters generated based on or as a function of one or more of: a nominal controlled output value derived from the nominal control strategy curves or functions, the actual controlled output set point value, the process variable set point value, and/or the actual process variable value.

6. (canceled)

7. The BMS optimization system according to claim 5 wherein the diagnosis time-series data streams comprises any one or more of the following deviation parameter values:
a controlled output deviation value representing a difference between the nominal controlled output value and the actual controlled output set point value;
a controlled output Euclidian distance value representing the Euclidian distance between the nominal controlled output value and the actual controlled output set point value;
a process variable deviation value representing a difference between the process variable set point value and the actual process variable value; and/or
a process variable Euclidian distance value representing the Euclidian distance between the process variable set point value and the actual process variable value.

8. The BMS optimization system according to claim 4 wherein the FDD engine comprises a recommendation engine that is configured or operable to generate the recommendation data identifying the recommended optimized control strategies for each equipment instance and/or category of equipment instance based at least partly on or as a function of the diagnosis time-series data streams and a recommendation threshold parameter or parameters.

9. The BMS optimization system according to claim 3 wherein the FDD engine further comprises:
an augmentation engine that is configured or operable to identify and augment the recommendation data for equipment instances with any existing override data associated with the one or more respective equipment instances, the override data being indicative of any overrides or modifications required to the recommendation data for any applicable equipment instances; and/or
a rollout planner process that is configured to: identify which equipment instances are designated for which stage of a progressive optimization rollout; determine which optimized control strategies are applicable for each equipment instances identified for each stage based on the recommendation data and any applicable override data; and generate rollout plan data indicative of the optimized control strategies applicable to the equipment instances at each stage of the rollout.

10. (canceled)

11. The BMS optimization system according to claim 9 wherein the FDD engine further comprises a rollout implementer engine that is configured to spawn and/or configure an optimizer process in the onsite controller for each equipment instance in accordance with the rollout plan data for each stage of the rollout, each optimizer process being configured to override one or more set points of its associated equipment instance generated by the pre-existing BMS in accordance with its linked optimized control strategy.

12. The BMS optimization system according to claim 1 wherein the onsite controller comprises one or more optimizer processes executing in an optimizer engine, each optimizer process being configured to override set points generated by the pre-existing BMS associated with the control of a respective equipment instance of the building in accordance with the recommended optimized control strategy for that equipment instance, and
wherein each optimizer process of the onsite controller for an equipment instance is configured to:
access or retrieve BMS time-series data representing the process variable set point value and actual process variable value; and
override or configure the controlled output set point value in the pre-existing BMS for the equipment instance to the nominal controlled output value extracted from the nominal control strategy curve or function associated with the recommended optimized control strategy for the equipment instance based at least partly on the BMS time-series data.

13. (canceled)

14. The BMS optimization system according to claim 11 wherein the FDD engine further comprises a verifier engine that is configured to process the digital building model, incoming BMS time-series data streams representing operation of the equipment instances of the building, and a nominal control strategy curve or function of the optimized control strategy being implemented by the optimizer process for each equipment instance to generate deviation parameters representing or indicative of a current operation of the equipment instances relative to their associated optimized control strategy, and
wherein the verifier engine is configured to generate fault data for one or more of the equipment instances based on comparing the deviation parameters to a verification threshold parameter or parameters.

15. (canceled)

16. The BMS optimization system according to claim 14 wherein the FDD engine further comprises a monitoring engine that is configured to process the digital building model, incoming BMS time-series data streams representing operation of the equipment instances of the building, and the nominal control strategy curve or function of the optimized control strategy being implemented by the optimizer process for each equipment instance to generate deviation parameters representing or indicative of the current operation of the equipment instances relative to their associated optimized control strategy, and
wherein the monitoring engine is configured to generate fault data for one or more of the equipment instances based on comparing the deviation parameters to a monitoring threshold parameter or parameters, and
wherein the verification threshold parameter(s) are configured with a higher sensitivity to error compared to the monitoring threshold parameter(s).

17-18. (canceled)

19. The BMS optimization system according to claim 1 wherein the onsite controller is an edge computer that is in data communication with the pre-existing BMS via a BMS communication protocol, and wherein the BMS communication protocol is BACnet.

20. (canceled)

21. The BMS optimization system according to claim 1 wherein the onsite controller is configured to override the set points of the pre-existing BMS via a command priority mechanism or system of a BMS communication protocol.

22. The BMS optimization system according to claim 1 wherein the onsite controller is configured to generate commands having an associated configured priority level for execution, the commands comprising set points for controlling equipment instances of the building and which are generated in accordance with the optimized control strategies, and wherein the commands generated by the onsite controller have a configured priority level for execution that is higher than commands generated by the pre-existing BMS such that the set points generated by the onsite controller override the set points generated by the pre-existing BMS.

23. (canceled)

24. The BMS optimization system according to claim 22 wherein commands generated by the onsite controller have a configured priority level for execution that is higher than commands generated by the pre-existing BMS and lower than a predetermined or configurable safety priority level; and/or wherein the onsite controller is in data communication with the pre-existing BMS via a BMS communication protocol comprising BACnet, and commands to control set points of equipment instances of the building are executed in accordance with a command priority array based on the priority level configured for generated commands.

25. (canceled)

26. The BMS optimization system according to claim 1 wherein the pre-existing BMS is agnostic to the overriding control of specific equipment instances of the building exerted by the onsite controller; and/or wherein the onsite controller is configured to override control of one or more aspects of the operation of specific equipment instances of the building in accordance with the optimized control strategies without requiring modification of the native control logic of the pre-existing BMS.

27. (canceled)

28. The BMS optimization system according to claim 1 wherein the pre-existing BMS continues to attempt to exert control over the equipment instances of the building in accordance with its native control logic by generating commands to control set points of one or more equipment instances, but wherein at least a portion of the BMS-generated set point commands are overridden by higher-priority commands generated by the onsite controller in accordance with the optimized control strategies.

29. The BMS optimization system according to claim 1 wherein the onsite controller is configured to exert overriding control over one or more aspects of the operation of specific equipment instances of the building based on the optimized control strategies, while any remaining aspects of the operation of equipment instances of the building remain controlled by the native control logic of the pre-existing BMS; and wherein the one or more aspects of the operation of specific equipment instances of the building overridden by the onsite controller comprises controlling specific sets or groups or areas of equipment instances of the building.

30. (canceled)

31. The BMS optimization system according to claim 1 wherein the pre-existing BMS seamlessly resumes full control of the operation of the specific equipment instances if the onsite controller goes offline, or wherein the pre-existing BMS resumes full control of the operation of the specific equipment instances by virtue of BMS-generated set point commands to control operation of the specific equipment instances becoming effective again once any overriding higher-priority set point commands from the offline onsite controller cease to override the BMS-generated set point commands.

32-33. (canceled)

34. A system for optimizing building behavior of a building to reduce energy consumption by equipment instances in the building comprising:
an optimization engine;
an analysis system that is configured to:
generate, receive and/or retrieve a digital building model of the building that at least identifies the equipment instances in the building;
analyze existing behavior of the equipment instances in the building and generate or select one or more optimized control strategies from a strategy library for execution by the optimization engine to improve one or more aspects of the operation of specific equipment instances in the building; and
a pre-existing building management system (BMS) executing native control logic to control a behavior of the equipment instances in the building via BMS-generated set point commands, and
wherein the optimization engine that receives and executes the optimized control strategies to override set points of the native control logic of the pre-existing BMS by generating higher-priority set point commands than the BMS-generated set point commands to improve the one or more aspects of the operation of the specific equipment instances in the building.

35. The system according to claim 34 wherein the commands comprise set points for controlling equipment instances of the building; and/or wherein the commands are generated and executed in accordance with a BMS communication protocol to control equipment instances of the building.

36-37. (canceled)

38. The system according to claim 35 wherein the commands are executed in accordance with a command prioritization mechanism or system of the BMS communication protocol; and/or wherein the BMS communication protocol is BACnet and the equipment instances are BACnet devices, and wherein the commands are executed in accordance with a command prioritization mechanism or system comprising a command priority array in BACnet.

39. (canceled)

40. The system according to claim 34 wherein each generated command comprises a configurable command priority level that determines its priority of execution relative to other competing commands.

41. The system according to claim 34 wherein the analysis system is a remote or cloud-based system or platform, and wherein the analysis system is in data communication with the optimization engine over a data network.

42. (canceled)

43. The system according to claim 34 wherein the optimization engine is a separate device, interface or controller that connects or interfaces with the pre-existing BMS; and/or wherein the optimization engine is retrofittable to or with the pre-existing BMS; and/or wherein the optimization engine is provided in an edge computer that interfaces or is in data communication with the pre-existing BMS

44-45. (canceled)

46. The system according to claim 34 wherein the optimization engine is in data communication with the pre-existing BMS via a BACnet communication protocol.

47. The system according to claim 34 wherein the optimization engine is installed onsite at the building; and/or wherein the optimization engine and pre-existing BMS are virtual machines or software applications which may operate within the same or different computing systems; and/or wherein the optimization engine is remote or installed offsite from the building.

48-50. (canceled)

51. An optimization engine for optimizing a pre-existing building management system (BMS) of a building, the pre-existing BMS executing native control logic to control building behavior via BMS-generated set point commands, the optimization engine comprising:
an interface for data communication with the pre-existing BMS of a building and/or equipment instances of the building;
memory for storing one or more optimized control strategies selected from a strategy library that are configured to improve one or more aspects of the operation of specific equipment instances in the building; and
a processor or application configured to execute the one or more optimized control strategies to override set points of the native control logic of the pre-existing BMS by generating higher-priority set point commands than the BMS-generated set point commands to thereby improve the one or more aspects of the operation of specific equipment instances in the building.

52. The optimization engine according to claim 51 wherein the optimization engine comprises or is in the form of an edge computer that is in data communication with the pre-existing BMS; or wherein the optimization engine is a virtual machine or software application.

53-62. (canceled)
